(19) United States
(12) Patent Application Publication
(10) Pub. No.: US 2005/0222882 A1
(43) Pub. Date: Oct. 6, 2005

(54) Quality problem treatment supporting system

(75) Inventors: Mariko Aoki, Tokyo (JP); Takamasa Itou, Tokyo (JP); Daisuke Mamiya, Tokyo (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/094,566

(22) Filed: Mar. 30, 2005

(30) Foreign Application Priority Data
Mar. 31, 2004 (JP) 2004-107414

(51) Int. Cl. G06F 7/00; G06F 17/30; G06F 17/60

(52) U.S. Cl. 705/7

(57) ABSTRACT

A quality problem treatment supporting system includes a storage portion and a processing portion. The processing portion includes a claim code checking program; a parts number checking program; an attached file search program; a temporal registration data determination program; a claim history data determination program; a delivery result search program; a classification data generation program; an investigation-execution-section determination section; a formal registration execution program; an investigation request message generation program; a past status determination program; a continuous failure determination program; a post-processing data generation program; a defect responsibility rate calculation program; a price data extraction program; an expense data extraction program; a remuneration calculation program; a monetary amount calculation program; and an payment amount determination program; and a monetary amount information transmission program.

### BACKGROUND OF THE INVENTION

1. Field of the Invention

The present invention relates to a quality problem treatment supporting system for appropriately executing a grievance procedure when a problem occurs in the market on a product delivered from a manufacturer to a sales dealer.

2. Description of the Related Art

A manufacturer for manufacturing industrial products must take its responsibility on products manufactured thereby. The manufacturer is required to perform an appropriate procedure when a market quality problem (failure or unpredicted performance deterioration) occurs on the product manufactured by the manufacturer. As an example of the procedure usable when the market quality problem has occurred, the procedure is known wherein a report (hereinafter referred to as “claim report”) is created for reporting a problem occurrence status of the parts receiving damages by the market quality problem. Then, a request for analysis of the problem is issued to the manufacturer side. Ordinarily, such a claim report is accompanied by a document (such as a guarantee certificate) relevant to the parts and is sent to the manufacturing side. There is another procedure wherein, together with such documents as described above, a sales dealer sends the parts of the analysis object to a service technical department (hereinafter referred to as “analysis unit”) of the manufacturer side, whereby the analysis of the actual parts is performed thereby to find the cause of the market problem.

A claim report created by a sales side located geographically near a manufacturer side promptly arrives at the manufacturer side, so that the sales side can promptly obtain a response to the claim report. However, for a sales side having a base in a location (for example, an isolated island) with unsuitable geographical conditions, in some cases, it is difficult to promptly receive the response to the created claim report. In addition, after once having created and sent the claim report to the manufacturer side, it is difficult to acquire a progress status thereof. To perform the appropriate procedure when the market quality problem has occurred on the manufactured product, a system for reporting a problem occurrence status of the parts suffering the market quality problem to the manufacturer side is very important for improving the reliability of products being distributed to markets.

Not only such the case of geographical conditions, but also other cases can take place wherein the claim report cannot easily be received on the sales side. For example, as faults on the sales side, information, which should be written in the claim report, is not written or correct. In such a case, it takes a time to select an appropriate analysis unit, thereby impeding the implementation of time reduction for analysis operation.

It is desired to provide a system that enables a manufacturer side to appropriately and promptly verify descriptions of a claim report created by a sales side.

It is also desired to provide a system that the reimbursement promptly arrives at the claim occurrence source, regardless of the suitable or unsuitable geographical conditions, in the case that an reimbursement should be paid against the claim problem based on a result of the analysis procedure on the parts suffering the claim problem, while such a system as described above is maintained.

Further, it is also desired to provide a system that enables the sales side creating the claim report to check the progress status of the parts analysis performed in response to the claim report.

In conjunction with the above description, Japanese Laid Open Patent Application No. JP 2002-366689 A discloses a following quality information system. The quality information system includes a quality-in-factory database, a product-quality database, a quality fault analysis means, an action contents database and a reference authorization server. The quality-in-factory database stores results of inspection conducted to completion products as inspection result data. The product-quality database stores fault events of the products discovered in dealers of a commercial scene as quality associated data. The quality fault analysis means specify causes of the fault events based on the inspection result data and the quality associated data. The action contents database stores treatments and actions performed to the causes specified by the quality fault analysis means. The reference authorization server permits reference of the data of the action contents database to the terminal of the dealer.

### SUMMARY OF THE INVENTION

Accordingly, an object of the present invention is to provide a system that enables a sales side creating a claim report to check a progress status of a parts analysis performed in response to the claim report.

Another object or the present invention is to provide a system that reimbursement promptly arrives at the claim occurrence source, regardless of the suitable or unsuitable geographical conditions, in the case that the reimbursement should be paid against the claim problem based on a result of the analysis procedure on the parts suffering the claim problem.

Still another object of the present invention is to provide a system that enables a manufacturer side to appropriately and promptly verify descriptions of a claim report created by a sales side.

This and other objects, features and advantages of the present invention will be readily ascertained by referring to the following description and drawings.

In order to achieve an aspect of the present invention, the present invention provides a quality problem treatment supporting system including: a temporary registration database which receives an e-mail including information with respect to a defect on a parts placing on the market, and stores the information as a temporal registration data; a claim code database which stores claim code data used to specify the defect; a claim code checking section which extracts a post-temporal registration claim code data from the temporal registration data read out from the temporary registration database, retrieves the claim code database, and determines whether a first claim code data corresponding to the post-temporal registration claim code data is stored in the claim code database; a parts number database which stores parts number data used to specify a parts in which a defect has occurred; a parts number checking section which extracts a post-temporal registration parts number data from the temporal registration data, retrieves the parts number database, and determines whether a first parts number data corresponding to the post-temporal registration parts number data is stored in the parts number database, when the first claim code data is stored in the claim code database; an attached file search section which determines whether an attached image data is actually attached to the temporal registration data as an attached file of the e-mail, when the first parts number data is stored in the parts number database and it is necessary for the temporal registration data to have attached image data; a temporal registration data determination section which determines whether the temporal registration data conforms to a predetermined rule to be appropriate; a claim history database which stores parts number data and claim history data, the parts number data and the claim history data are related to each other; a claim history data determination section which retrieves the claim history database, and determines whether a first claim history data corresponding to the post-temporal registration parts number data is stored in the claim history database, when the temporal registration data is appropriate; a delivery result database which stores delivery result data indicating delivery results of parts corresponding to parts data; a delivery result search section which retrieves the delivery result database, and determines whether a first delivery result data indicating a delivery result of a parts corresponding to the post-temporal registration parts number data is stored in the delivery result database; a classification data generation section which classifies an occurrence cause of a defect corresponding to the temporal registration data which is appropriate based on the post-temporal registration claim code data extracted by the claim code checking section, and generates a classification data, when the first delivery result data is stored in the delivery result database; an investigation-execution-section determination section determines an investigation execution section that investigates countermeasures on the occurrence causes, based on the classification data; a formal registration execution section which registers the temporal registration data as a formal registration data in a formal registration database; a investigation request message generation section which generates an investigation execution request message indicating a request for investigation execution, and sends to the investigation execution section; a countermeasure status database which stores countermeasure status data indicating countermeasure statuses of past defects of the parts; a past status determination section which extracts the formal registration data from the formal registration database, retrieves the countermeasure status database, determines whether a countermeasure was executed in the past on a defect data same as a first defect data indicating the defect contained in the formal registration data, and transmits a first countermeasure execution data indicating a new countermeasure submitted by the investigation execution section to the e-mail sender when the countermeasure was not executed; a continuous failure determination section which determines whether the first defect data includes a data with respect to a continuous failure, when the countermeasure was executed in the past on the first defect data, and transmits a second countermeasure execution data indicating the countermeasure extracted from the countermeasure status database to the e-mail sender when the first defect data includes the data with respect to the continuous failure; a post-processing data generation section which generates a post-processing data in which the formal registration data is related to the determination results by the past status determination section and the continuous failure determination section, and stores the post-processing data in the formal registration database; a defect responsibility rate calculation section which calculates a defect responsibility rate based on the post-processing data; a price database which stores parts price data indicating market supply prices of parts corresponding to the parts number; an expense database which stores expense data indicating expenses when parts are supplied; a price data extraction section which retrieves the price database, and extracts a price data indicating a price of a first parts corresponding to a parts number included in the post-processing data; an expense data extraction section which retrieves the expense database, and extracts an expense data indicating an market supply expense of the first parts; a remuneration calculation section which calculates a remuneration data based on the defect responsibility rate, the price data and the expense data; a monetary amount calculation section which calculates a monetary amount based on the remuneration data and an exchange rate; a payment amount determination section which determines an actual payment amount based on the monetary amount; and a monetary amount information transmission section which generates a payment notice message notifying the payment amount, and transmits another e-mail including the payment notice message to a sender of the e-mail. The sender executes one of the countermeasure and the new countermeasure in the countermeasure execution data to repair said defect.

In the quality problem treatment supporting system, the temporal registration data determination section may generate an impropriety message, and transmit still another e-mail including the impropriety message to the sender of the e-mail, when the temporal registration data determination section determines the temporal registration data is not appropriate.

In the quality problem treatment supporting system, at least one of the past status determination section and the continuous failure determination section may generate a post-countermeasure data indicating a countermeasure completion, and store the post-countermeasure data, which is related to the parts number data included in the formal registration data, in the countermeasure status database, when the countermeasure was executed in the past on the first defect data.

In order to achieve another aspect of the present invention, the present invention provides a quality problem treatment supporting method including: (a) reading out a temporal registration data, which indicates information with respect to a defect on a parts placing on the market, from a temporary registration database; (b) extracting a post-temporal registration claim code data from the temporal registration data, retrieving a claim code database storing claim code data used to specify the defect, and determining whether a first claim code data corresponding to the post-temporal registration claim code data is stored in the claim code database; (c) extracting a post-temporal registration parts number data from the temporal registration data, retrieves a parts number database storing parts number data used to specify a parts in which a defect has occurred, and determining whether a first parts number data corresponding to the post-temporal registration parts number data is stored in the parts number database, when the first claim code data is stored in the claim code database; (d) determining whether an attached image data is actually attached to the temporal registration data as an attached file of the e-mail, when the first parts number data is stored in the parts number database and it is necessary for the temporal registration data to have attached image data; (e) determining whether the temporal registration data conforms to a predetermined rule to be appropriate; (f) retrieving a claim history database storing parts number data and claim history data in which the parts number data and the claim history data are related to each other, and determining whether a first claim history data corresponding to the post-temporal registration parts number data is stored in the claim history database, when the temporal registration data is appropriate; (g) retrieving a delivery result database storing delivery result data indicating delivery results of parts corresponding to parts data, and determines whether a first delivery result data indicating a delivery result of a parts corresponding to the post-temporal registration parts number data is stored in the delivery result database; (h) classifying an occurrence cause of a defect corresponding to the temporal registration data which is appropriate based on the post-temporal registration claim code data extracted by the step (b), and generates a classification data, when the first delivery result data is stored in the delivery result database; (i) determining an investigation execution section that investigates countermeasures on the occurrence causes, based on the classification data; (j) registering the temporal registration data as a formal registration data in a formal registration database; (k) generating an investigation execution request message indicating a request for investigation execution, and sends to the investigation execution section; (l) extracting the formal registration data from the formal registration database, retrieves a countermeasure status database storing countermeasure status data indicating countermeasure statuses of past defects of the parts, determining whether a countermeasure was executed in the past on a defect data same as a first defect data indicating the defect contained in the formal registration data, and transmitting a first countermeasure execution data indicating a new countermeasure submitted by the investigation execution section to the e-mail sender when the countermeasure was not executed; (m) determining whether the first defect data includes a data with respect to a continuous failure, when the countermeasure was executed in the past on the first defect data, and transmitting a second countermeasure execution data indicating the countermeasure extracted from the countermeasure status database to the e-mail sender when the first defect data includes the data with respect to said continuous failure; (n) generating a post-processing data in which the formal registration data is related to the determination results by the step (l) and the step (m), and storing the post-processing data in the formal registration database; (o) calculating a defect responsibility rate based on the post-processing data; (p) retrieving a price database storing parts price data indicating market supply prices of parts corresponding to the parts number, and extracting a price data indicating a price of a first parts corresponding to a parts number included in the post-processing data; (q) retrieving an expense database storing expense data indicating expenses when parts are supplied, and extracting an expense data indicating an market supply expense of the first parts; (r) calculating a remuneration data based on the defect responsibility rate, the price data and the expense data; (s) calculating a monetary amount based on the remuneration data and an exchange rate; (t) determining an actual payment amount based on the monetary amount; (u) generating a payment notice message notifying the payment amount, and transmitting another e-mail with the payment notice message to a sender of the e-mail; (v) generating an impropriety message, and transmitting still another e-mail with the impropriety message to the sender of the e-mail, when determining the temporal registration data is not appropriate in the step (e); and (w) generating a post-countermeasure data indicating a countermeasure completion, and stores the post-countermeasure data, which is related to the parts number data included in the formal registration data, in the countermeasure status database, when the countermeasure was executed in the past on the first defect data, wherein an information terminal of the e-mail sender displays the countermeasure execution data on a display to execute one of the countermeasure and the new countermeasure for repairing the defect.

The quality problem treatment supporting method further includes (x) executing one of the countermeasure and the new countermeasure indicated in the countermeasure execution data to repair the defect the sender.

In order to achieve still another aspect of the present invention, the present invention provides a Computer program product with program code means for carrying out all steps in the quality problem treatment supporting method shown above if the program runs on a computer.

The Computer program product with program code means may be stored on a storage means which can be read by the computer.

The present invention is advantageous in that a sales side creating a claim report can verify, by necessity, a progress status of a parts analysis performed in response to the claim report.

The present invention is further advantageous in that a claim report is promptly received to be able to start an analysis procedure, and particularly in the event that, as the analysis procedure result of the parts suffering the claim, the reimbursement corresponding to the claim can be transmitted to promptly arrive at the claim occurrence source, regardless of the suitable or unsuitable geographical conditions.

### BRIEF DESCRIPTION OF THE DRAWINGS

FIG. 1 is a block diagram showing the configuration of the first embodiment of the present invention;

FIG. 2 is a block diagram showing a storage portion (52) according to the first embodiment;

FIG. 3 is a block diagram showing a storage portion (53) according to the first embodiment;

FIGS. 4A to 4D are flowcharts illustrating operation of a system according to the first embodiment;

FIG. 5 is a block diagram showing the configuration of the second embodiment of the present invention;

FIG. 6 is a diagram showing a claim report (20) according the second embodiment;

FIG. 7 is a diagram showing an authentication table (30) according to the second embodiment;

FIG. 8 is a diagram showing a claim analysis table (40) according to the second embodiment;

FIG. 9 is a diagram showing the configuration of a claim report management table (50) according to the second embodiment;

FIG. 10 is a diagram showing the configuration of a diagnosis result table (60) according to the second embodiment;

FIGS. 11A, 11B, 12A and 12B are sequence charts illustrating operation of a system according to the second embodiment;

FIG. 13 is a flowchart illustrating the operation of the system according to the second embodiment;

FIG. 14 is a flowchart illustrating operation in the event of inputting claim information according to the second embodiment;

FIG. 15 is a flowchart illustrating operation in the event of determination of a analysis unit according to the second embodiment;

FIG. 16 is a flowchart illustrating operation in the event of verifying the status according to the second embodiment; and

FIG. 17 is a flowchart illustrating operation of time limit management according to the second embodiment.

### DESCRIPTION OF THE PREFERRED EMBODIMENTS

Preferred embodiments of a quality problem treatment supporting system according to the present invention will be described below with reference to attached drawings.

### Configuration of the First Embodiment

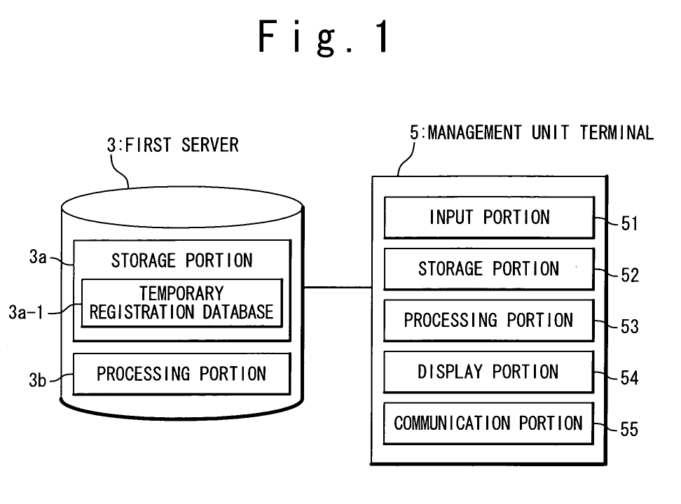

FIG. 1 is a block diagram showing the configuration of the first embodiment of the present invention. Referring to FIG. 1, a quality problem treatment supporting system according to the first embodiment includes a sales side and a management/analysis side. The sales side practically performs, for example, sales, maintenance, and replacement of parts of products distributed to markets for customers. The management/analysis side performs, for example, analysis operation on claim reports sent from the sales side. In the system, a first server 3 and a management unit terminal 5 are connected together, and predetermined information processing is executed, whereby desirable processing results are obtained.

The first server 3, when information regarding a defect occurred with the parts supplied to markets has been transmitted, temporarily stores the information into a temporary registration database. The first server 3 has a storage portion 3a and a processing portion 3b. The storage portion 3a is an internal device or an external device connected to the first server 3, which is an information storage function block provided in the first server 3. The storage portion 3a has an information storage function such as a magnetic storage medium or a semiconductor memory, whereby to store received information and the like into the temporary registration database 3a-1. The processing portion 3b is a computing operation function block provided in the first server 3. The processing portion 3b has the CPU (central processing unit), whereby to perform information processing in response to the input of transmitted information. The temporary registration database 3a-1 receives information with respect to a defect on a parts placing on the market, and stores the information as a temporal registration data. The temporary registration database 3a-1 may be included in the management unit terminal 5.

The management unit terminal 5 is an information processing terminal capable of executing electronic processing on input information. The management unit performs tasks such as checking of a format on claim reports transmitted from the sales side, and selecting of a analysis unit suitable to perform the analysis of the claim reports. After checking of the format, the management unit terminal 5 performs an analysis operation corresponding to a plurality of transmitted claim reports. The management unit terminal 5 has an input portion 51, a storage portion 52, a processing portion 53, a display portion 54, and a communication portion 55.

The input portion 51 is an information input function block provided in the management unit terminal 5. The input portion 51 has information input functions such as a keyboard capable of inputting characters, a sound collecting unit (microphone) capable of inputting sound, and a touch panel provided to a display screen. The input portion 51 connects to the processing portion 53. The information entered from the input portion 51 is outputted to the processing portion 53. The input portion 51 further connects to the storage portion 52. The information inputted from the input portion 51 is outputted to the storage portion 52 as well.

The storage portion 52 is an information storage function block provided in the management unit terminal 5. The storage portion 52 is built-in or externally connected to the management unit terminal 5. The storage portion 52 has an information storage function, such as a magnetic storage medium or semiconductor memory. The storage portion 52 stores for example, the information inputted from the input portion 51, and information received through a network or leased line.

The processing portion 53 is an computing operation function block provided in the management unit terminal 5. The processing portion 53 has the CPU (central processing unit) thereby to perform information processing in response to the input of information transmitted through the network, leased line or the like. The processing portion 53 performs information processing in response to the input of information from the input portion 51. The processing portion 53 instructs the storage portion 52 to execute information updating in response to the information processing executed by the processing portion 53 itself. The storage portion 52 updates the stored information.

The display portion 54 is an information display function block provided in the management unit terminal 5. The display portion 54 has, for example, a display having a display screen, and a speaker performing sound output. The management unit terminal 5 reports through the display portion 54 information to a responsible staff in the management unit using the management unit terminal 5.

The communication portion 55 is a communication control function block provided in the management unit terminal 5. The communication portion 55 has a communication interface for performing information communication. The communication portion 55 inputs and/or outputs information transmitted and/or received through the communication interface. Additionally, the communication portion 55 receives, through the communication interface, information transmitted through a network or leased line. The communication portion 55 is connected to an intra-system network provided in the system, thereby to perform information communication through the intra-system network.

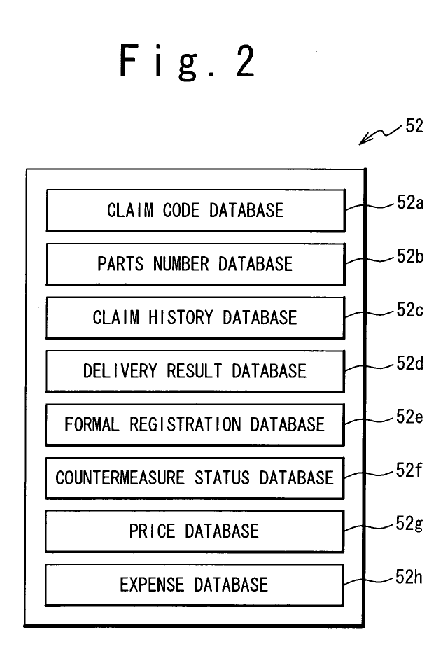

FIG. 2 is a diagram showing an interior configuration of the storage portion 52. Referring to FIG. 2, the storage portion 52 includes a claim code database 52a; a parts number database 52b; a claim history database 52c; a delivery result database 52d; a formal registration database 52e; a countermeasure status database 52f; a price database 52g; and an expense database 52h. The claim code database 52a stores a plurality of claim code data used to specify defects. The parts number database 52b stores a plurality of parts number data used to specify defective parts, in which a defect has occurred. The claim history database 52c stores a plurality of parts number data and claim history data, in which the plurality of parts number data and claim history data are related each other. The delivery result database 52d stores delivery result data indicative of delivery results of parts corresponding to a plurality of parts data. The formal registration database 52e stored information transferred from the temporary registration database as formal registration data. The countermeasure status database 52f stores countermeasure status data indicative of countermeasure statuses of past defects of parts. The price database 52g stores parts price data indicative of prices of parts supplied to the market. The expense database 52h stores expense data indicative of expenses in the event of supplying parts.

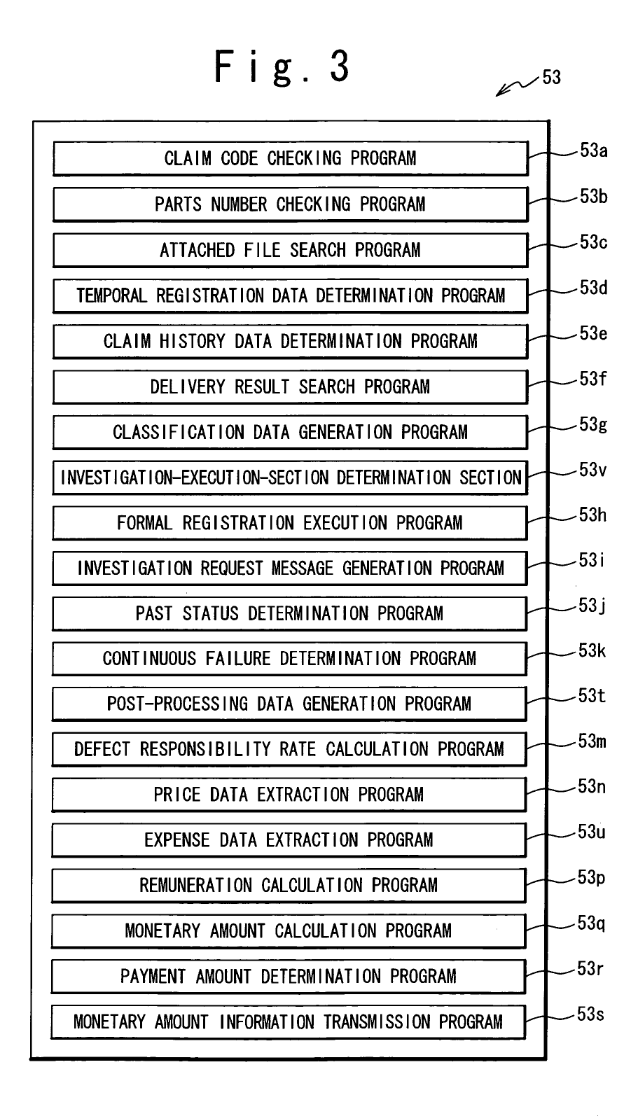

FIG. 3 is a diagram showing a plurality of processing programs contained in the processing portion 53. Referring to FIG. 3, the processing portion 53 includes a claim code checking program 53a; a parts number checking program 53b; an attached file search program 53c; a temporal registration data determination program 53d; a claim history data determination program 53e; a delivery result search program 53f; a classification data generation program 53g; an investigation-execution-section determination section 53v; a formal registration execution program 53h; an investigation request message generation program 53i; a past status determination program 53j; a continuous failure determination program 53k; a post-processing data generation program 53t; a defect responsibility rate calculation program 53m; a price data extraction program 53n; an expense data extraction program 53u; a remuneration calculation program 53p; a monetary amount calculation program 53q; an payment amount determination program 53r; and a monetary amount information transmission program 53s. The claim code checking program 53a performs comparisons to determine whether a code, corresponding to a code contained in a specific file, is stored in a database. The parts number checking program 53b performs comparisons to determine whether a parts number, corresponding to a parts number contained in a specific file, is stored in a database. The attached file search program 53c determines whether an attached file necessary for an specific file is actually attached. The temporal registration data determination program 53d determines whether a specific file contents conforms to a predetermined rule. The claim history data determination program 53e determines whether information processing for a code contained in a specific file has been executed in the past. The delivery result search program 53f determines whether a result corresponding to a code contained in a specific file exists. The classification data generation program 53g classifies a code contained in a specific file in relation with a predetermined classification rule. The investigation-execution-section determination section 53v determines an investigation execution section that investigates countermeasures on the occurrence causes of the defect. The formal registration execution program 53h registers the temporal registration data as a formal registration data in a database. The investigation request message generation program 53i generates a message for being transmitted through a network. The past status determination program 53j determines whether information processing for a specific file has been executed in the past. The continuous failure determination program 53k determines whether a defect reported by a specific file is a continuous failure. The post-processing data generation program 53t generates a post-processing data in which the formal registration data is related to the determination results by the past status determination program 53j and the continuous failure determination program 53k. The defect responsibility rate calculation program 53m calculates a defect responsibility rate for a defect reported by a specific file. The price data extraction program 53n extracts price data. The expense data extraction program 53u extracts expense data. The remuneration calculation program 53p calculates a remuneration based on the price data and the expense data. The monetary amount calculation program 53q calculates a monetary amount based on an exchange rate. The payment amount determination program 53r determines an actual payment amount. The monetary amount information transmission program 53s transmits at least one item of information regarding the monetary amount to a predetermined mail address.

### Operation of the First Embodiment

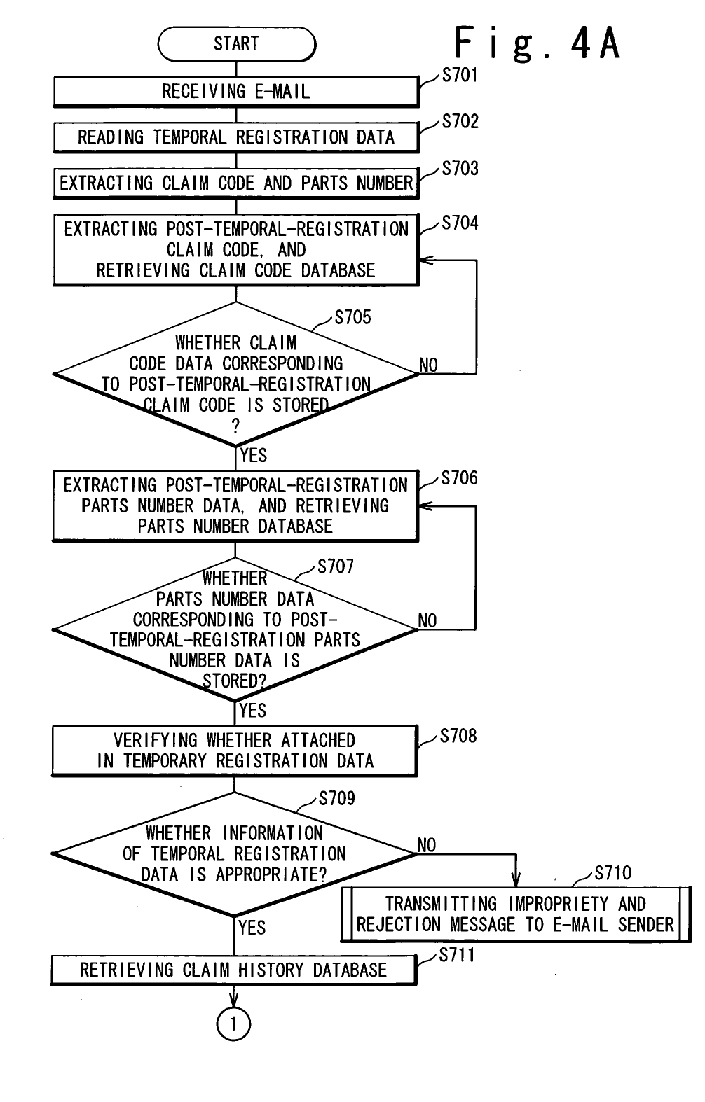

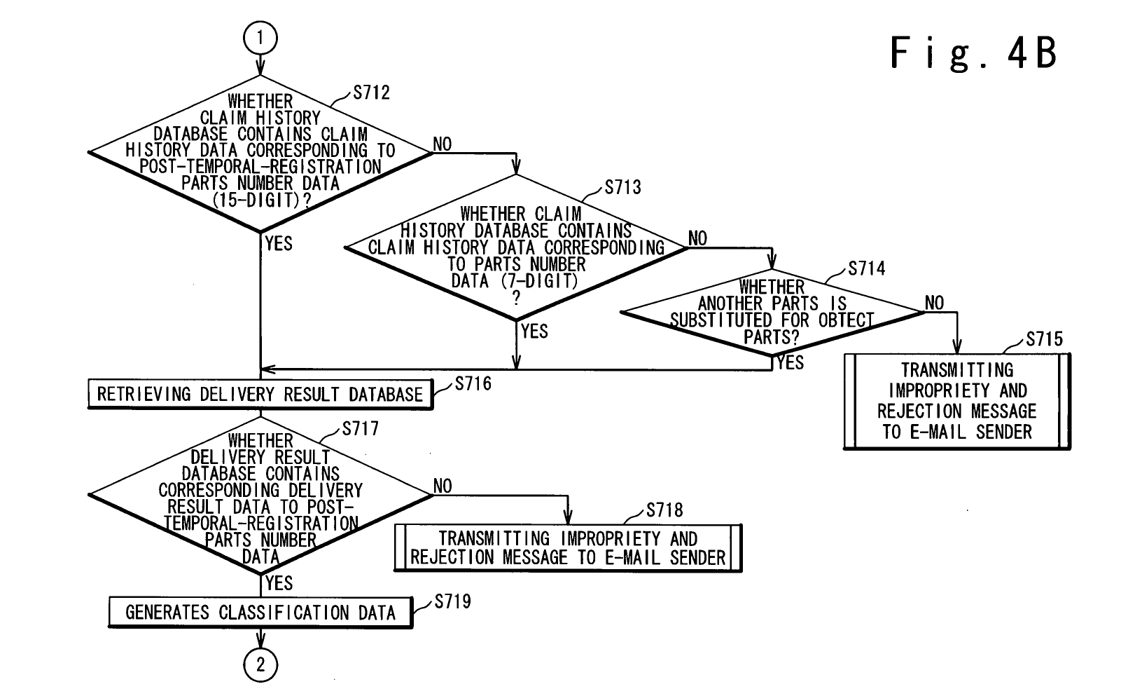

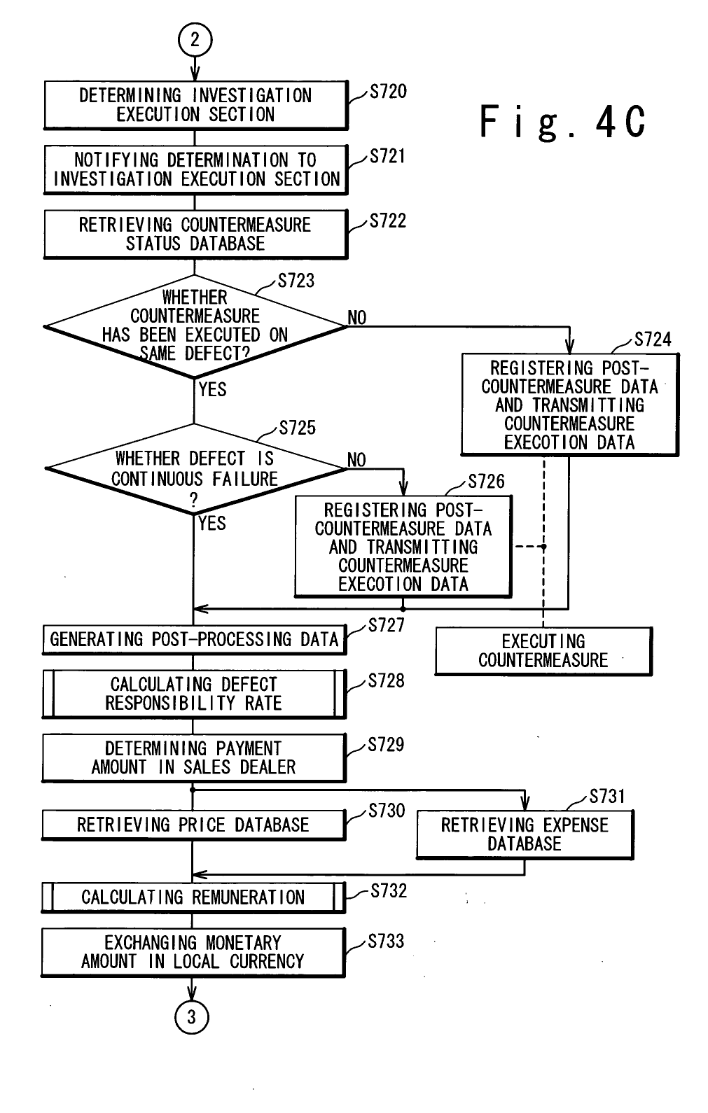

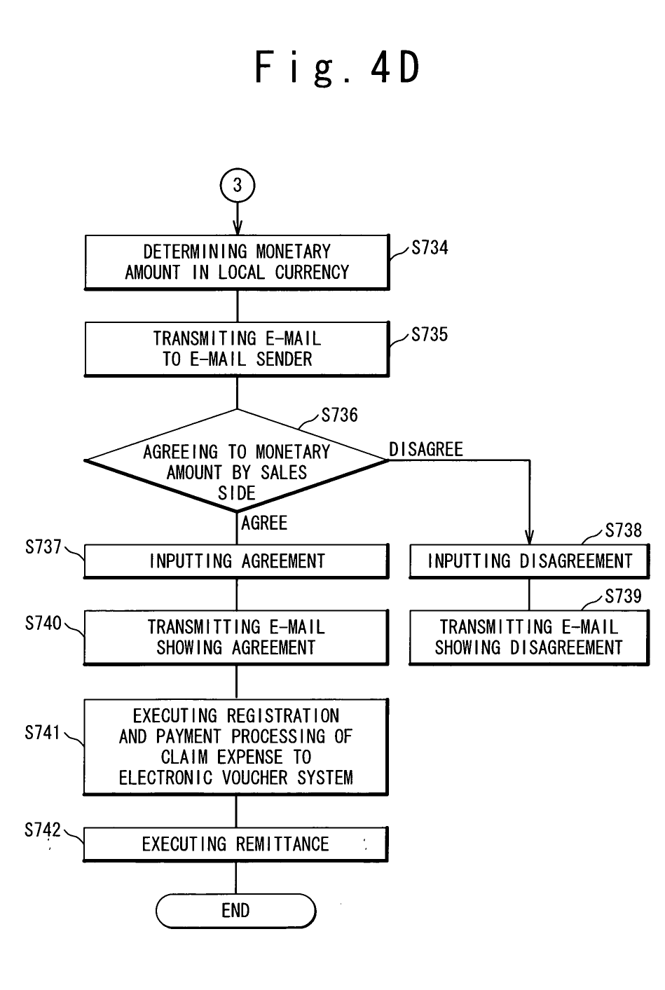

An operation of the first embodiment of the present invention will be described below with reference to the drawings. FIGS. 4A to 4D are flowcharts indicative of operation of the first embodiment. In the step S701, the management unit terminal 5 receives the e-mail including information with respect to a defect occurred with the parts supplied to the market. In the step S702, the claim code checking program 53 accesses the temporary registration database 3a-1 in response to the e-mail and reads temporal registration data. In the step S703, the claim code checking program 53 reads a claim code and a parts number from the temporal registration data.

In the step S704, the claim code checking program 53 accesses the claim code database 52a that contains the plurality of the claim code data for being used to specify individual defects. Thereby, the claim code checking program 53 extracts a post-temporal-registration claim code contained in the temporal registration data read out from the temporary registration database 3a-1. Then, in response to completion of the extraction of the post-temporal-registration claim code, the claim code checking program 53 searches the claim code database 52a as shown below.

In the step S705, the claim code checking program 53a determines whether the claim code data corresponding to the post-temporal-registration claim code is stored in the plurality of the claim code data stored in the claim code database 52a. This processing is performed until the corresponding claim code data is extracted. In the event that the corresponding claim code data has been extracted, the processing proceeds to the step S706. In the step S706, the parts number checking program 53b accesses the parts number database 52b that contains the plurality of parts number data individually used to specify defective parts. Thereby, the parts number checking program 53b extracts the post-temporal-registration parts number data contained in the temporal registration data. Then, in response to completion of the extraction of the post-temporal-registration parts number data, the parts number checking program 53b searches the parts number database 52b as shown below.

In the step S707, the parts number checking program 53b determines whether the parts number data corresponding to the post-temporal-registration parts number data is stored in the plurality of parts number data stored in the parts number database 52b. As a result of the determination of the step S707, when the parts number data corresponding to the post-temporal-registration parts number data is stored, and concurrently, when the temporal registration data is information requiring the attached image data, the attached file search program 53c verifies whether the attached image data is attached in the form of an attached file of the e-mail (at S708).

In the step S709, in response to completion of the checking of the claim code by the claim code checking program 53a and checking of the parts number data by the parts number checking program 53b, the temporal registration data determination program 53d extracts the temporal registration data, and determines whether information indicated by the temporal registration data is appropriate. When determining that the information indicated by the temporal registration data is inappropriate, the temporal registration data determination program 53d generates an impropriety message for transmission to an information transmission source. Subsequently, the temporal registration data determination program 53d transmits the impropriety message to a mail address corresponding to the e-mail sender (the step S710).

In the step S711, in response to the result of the determination by the temporal registration data determination program 53d and to the impropriety event of the temporal registration data, the claim history data determination program 53e searches the claim history database 52c that contains the plurality of the parts number data individually in relation with claim history data. In the claim history database 52c, the parts number data related with the claim history data is represented by a 15-digit number. Each of the parts is assigned the number, so that the respective parts is specified by the number of 15 digits. The first half of the 15-digit number is a number used to specify the parts including a plurality of derivation parts, and the latter half of the 15-digit number is a number used to specify the derivation parts of the parts.

In the step S712, the claim history data determination program 53e determines-whether the claim history database 52c contains the claim history data corresponding to the post-temporal-registration parts number data. First, the determination starts with a search for a claim history corresponding to the 15-digit number, which is indicated by the post-temporal-registration parts number data, to know whether a claim history regarding the derivation parts (actual parts) exist (the step S712). When the claim history data corresponding to the 15-digit number cannot be found, the search is executed by using the first 7-digit portion of the 15-digit number. Thereby, the search range is widened, and the determination is made whether the database contains the claim history data corresponding to the parts number data of the parts including the relevant derivation parts (the step S713).

When corresponding claim history data cannot be found even with the first 7-digit portion, the claim history data determination program 53e searches the parts database storing data of substitutable parts, and extracts information indicating whether another parts is substituted for the parts. Then, based on the extracted information, the claim history data determination program 53e executes the claim history data search (the step S714). As a result of the processing from the steps S712 to S714, if no corresponding claim history data cannot be found, this processing is not performed because the parts is not manufactured or supplied to the e-mail sender. Therefore, the claim history data determination program 53e transmits the impropriety message to a mail address corresponding to the e-mail sender (the step S715).

As a consequence of the processing of from the steps S712 to S714, if the claim history data is found in any one of these steps, the processing proceeds to the step S716. In the step S716, the delivery result search program 53f searches the delivery result database 52d that contains delivery result data indicative of actual delivery results of parts corresponding to the plurality of parts data. Then, in the step S717, the delivery result search program 53f determines whether the database contains corresponding delivery result data indicative of the delivery results for the parts corresponding to the post-temporal-registration parts number data.

As a result of the determination of S717, the delivery result database 52d does not contain the corresponding delivery result data, further processing is not performed. The delivery result search program 53f transmits the impropriety message to a mail address corresponding to the e-mail sender (the step S718). The delivery result database 52d contains the corresponding delivery result data, the processing proceeds to the step S719. In the step S719, based on the post-temporal-registration claim code extracted by the claim code checking program 53a, the classification data generation program 53g classifies occurrence causes of the defect corresponding to temporal registration data determined by the temporal registration data determination program 53d to be appropriate. Then, the classification data generation program 53g generates a classification data.

In the step S720, based on the classification data, an investigation-execution-section determination section 53v determines an investigation execution section that investigates countermeasures on the occurrence causes of the defect corresponding to the temporal registration data in a predetermined rule. In the step S721, in response to completion of the generation of the classification data by the classification data generation program 53g and the determination by the investigation-execution-section determination section, the formal registration execution program 53h performs a formal registration of the temporal registration data as formal registration data into the formal registration database 52e. In response to completion of the formal registration, the investigation request message generation program 53i generates an investigation execution request message to the investigation execution section for the execution of countermeasures, and transmits it to a formal registration execution section.

In the step S722, in response to the received investigation execution request message, the past status determination program 53j extracts the formal registration data from the formal registration database 52e. Then, in response to completion of the extraction, the past status determination program 53j searches the countermeasure status database 52f that contains the countermeasure status data indicative of countermeasure statuses of past defects on parts. In the step S723, the past status determination program 53j determines whether the countermeasure has been executed on a past defect data similar to the defect data representing the defect-related information contained in the formal registration data. As a result of the determination, if no countermeasure has never been performed on the past defect data similar to the defect data, the investigation execution section studies to obtain a new countermeasure for the defect data. Then, the past status determination program 53j generates a post-countermeasure data indicative of the countermeasure completion, and stores it as a new post-countermeasure data in relation with the parts number data contained in the formal registration data in the countermeasure status database 52f. Also, the past status determination program 53j transmits a countermeasure execution data indicating the new countermeasure submitted by the investigation execution section to the e-mail sender (the step S724). Based on the countermeasure execution data displayed on a display of an information terminal of said e-mail sender, the e-mail sender (ex. the sales dealer, the repair shop) executes the new countermeasure, such as repairing the parts and replacing a part of the parts, substituting another parts for the parts, to treat the claim.

In the step S725, when a result of the determination by the past status determination program 53j is that the countermeasure has been before executed on the defect data, the continuous failure determination program 53k determines whether the defect data contains information regarding the continuous failure. When no continuous failure has before contained on the past defect data similar to the defect data, the continuous failure determination program 53k generates a post-countermeasure data indicative of countermeasure completion, and stores it as a new post-countermeasure data in relation with the parts number data contained in the formal registration data in the countermeasure status database 52f. Also, the continuous failure determination program 53k transmits a countermeasure execution data indicating the countermeasure before executed on the similar defect to the e-mail sender (the step S726). Based on the countermeasure execution data displayed on a display of an information terminal of said e-mail sender, the e-mail sender (ex. the sales dealer, the repair shop) executes the countermeasure, such as repairing the parts and replacing a part of the parts, substituting another parts for the parts, to treat the defect described in the claim report.

In the step S727, the post-processing data generation program 53t generates a post-processing data, in which the determination result obtained by the past status determination program 53j, the determination result obtained by the continuous failure determination program 53k, and the formal registration data are related with one another. Then, the post-processing data generation program 53t stores the post-processing data in the formal registration database 52e. The defect responsibility rate calculation program 53m calculates a defect responsibility rate based on the post-processing data (the step S728). The defect responsibility percentage is the percentage of responsibility of a parts supply source for the defect-occurring parts. Generally, the percentage is calculated corresponding to, for example, a negligence ratio on a detriment occurrence side and a negligence ratio on a physical distribution side.

In the step S729, the defect responsibility rate calculation program 53m determines a payment amount in the dealer, which is used as a base, based on the defect responsibility percentage. In the step S730, in response to completion of the calculation of the defect responsibility percentage, the price data extraction program 53n searches the price database 52g that contains parts price data indicative of market supply prices of parts corresponding to the plurality of parts number data. Thereby, the price data extraction program 53n extracts a parts price data indicative of a parts price of the parts corresponding to the parts number contained in the post-processing data. Similarly, in the step S731, in response to completion of the calculation of the defect responsibility percentage, the expense data extraction program 53u searches the expense database 52h that contains expense data indicative of expenses in the event that parts corresponding to the plurality of parts numbers are supplied to markets. Thereby, the expense data extraction program 53u extracts expense data indicative of expenses in the event that parts corresponding to parts numbers contained in the post-processing data are supplied to the markets.

The remuneration calculation program 53p calculates a predetermined remuneration data based on the defect responsibility percentage value determined by the defect responsibility rate calculation program 53m, the parts price data extracted by the price data extraction program 53n, and the expense data extracted by the expense data extraction program 53u (the step S732). Thereafter, when a currency-unit change is necessary, the monetary amount calculation program 53q calculates a monetary amount corresponding to a currency unit of currency with which payment is executed based on an exchange rate. The calculation is performed based on the remuneration data calculated by the remuneration calculation program 53p (the step S733). Then, the payment amount determination program 53r determines the monetary amount based on the calculation result by the monetary amount calculation program 53q (the step S734).

In the S735, the monetary amount information transmission program 53s generates a monetary amount notification message that notifies the monetary amount calculated by the monetary amount calculation program 53q. The monetary amount information transmission program 53s then transmits an e-mail including the monetary amount notification message to a mail address corresponding to the e-mail sender on the sales side that has created the claim report. When agreeing to the monetary amount information (the step S736: Yes), the sales side, which created the claim report, inputs an agreement (the step S737), thereby to transmit an e-mail showing the agreement to an electronic voucher system (the steps S740). When disagreement to the monetary amount information (the step S736: No), the sales side inputs a disagreement (the step S 738) thereby to transmit an e-mail showing the disagreement (the step S739).

In the step S741, the electronic voucher system, having received the agreement by the e-mail, executes registration processing and payment processing of the claim expense, and the processing of remittance to the sales side, which created the claim report (the step S742).

According to the operation described above, the responsible staff of the management unit can promptly specify the analysis unit, and the time necessary for the claim report processing tasks can be significantly reduced.

This operation can improve the speed of treating claims. That is, as the investigation execution section can be rapidly determined, the countermeasure can be speedily obtained. Therefore, the e-mail sender such as the sales dealer can promptly obtain the countermeasure for the defect regarding the claim. Hence, the e-mail sender can quickly treat the claims by, for example, repairing the parts, replacing a part of the parts, and substituting another parts for the parts, and enables to avoid problem occurrence resulted from a processing delay. Also, the account processing for the parts regarding the claim can be promptly treated.

### Configuration of the Second Embodiment

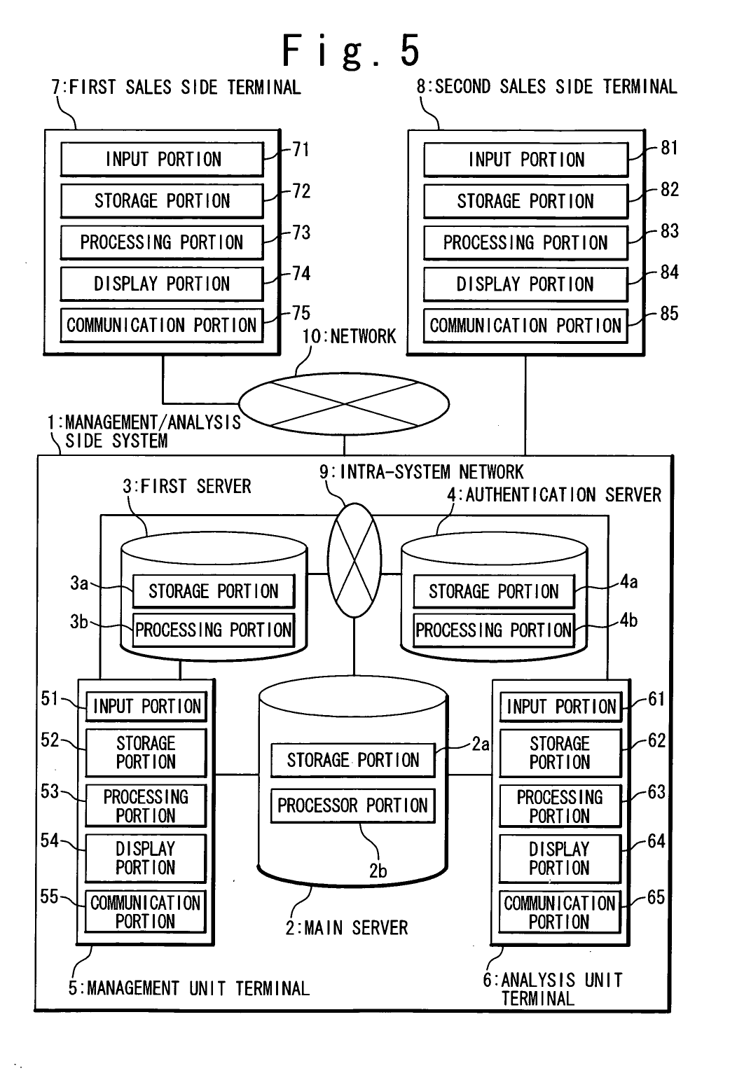

FIG. 5 is a block diagram showing the configuration of the second embodiment of the present invention. Referring to FIG. 5, a quality problem treatment supporting system according to the present embodiment is configured of a sales side and a management/analysis side 1. The sales side practically performs, for example, sales, maintenance, and replacement of parts of products distributed to markets. The management/analysis side 1 performs, for example, analysis work on claim reports sent from the sales side. The sales side is configured of a first sales side terminal 7 connecting to the management/analysis side 1 through a network 10, and a second sales side terminal 8 connecting to the management/analysis side 1 through a leased line. The management/analysis side 1 is configured of a main server 2, a first server 3, an authentication server 4, a management unit terminal 5, and a analysis unit terminal 6, which are interconnected through an intra-system network 9.

The main server 2 is an information processing unit provided in the system. The main server 2 has a storage portion 2a and a processor portion 2b, wherein the storage portion 2a stores a main database. The storage portion 2a is an information storage function block provided in the main server 2. The storage portion 2a is built-in or externally connected to the main server 2. The storage portion 2a has an information storage function, such as a magnetic storage medium or a semiconductor memory, wherein the storage portion 2a stores, for example, information which is inputted through the intra-system network 9 and information received through the network 10 and/or a leased line. The processor portion 2b is a computing operation function block provided in the main server 2. The processor portion 2b has the CPU (central processing unit) thereby to perform information processing in response to the input of information transmitted through the network 10 and/or leased line. In addition, the processor portion 2b performs information processing in response to information which is inputted through the intra-system network 9. The processor portion 2b issues an instruction to the storage portion 2a to execute information updating in relation with the information processing executed by the processor portion 2b itself. In response to the instruction, the storage portion 2a updates information being stored.

The first server 3 temporarily stores information transmitted from either the first sales side terminal 7 or the second sales side terminal 8. The first server 3 has a storage portion 3a and a processing portion 3b. The storage portion 3a is an information storage function block provided in the first server 3. The storage portion 3a is built-in or externally connected to the first server 3. The storage portion 3a has an information storage function, such as a magnetic storage medium or a semiconductor memory, wherein the storage portion 3a stores, for example, information which is inputted through the intra-system network 9 and information received through the network 10 and/or a leased line. The processing portion 3b is a computing operation function block provided in the first server 3. The processing portion 3b has the CPU (central processing unit) thereby to perform information processing in response to the input of information transmitted through the network 10 and/or leased line. In addition, the processing portion 3b performs information processing in response to information which is input through the intra-system network 9. The processing portion 3b issues an instruction to the storage portion 3a to execute information updating in relation with the information processing executed by the processing portion 3b itself. In response to the instruction, the storage portion 3a updates information being stored.

The authentication server 4 stores information that is used to perform an authentication of whether to issue an access permission in response to an access request for access to the system. The authentication server 4 has a storage portion 4a and a processor portion 4b. The storage portion 4a stores a database that is used when authenticating a user. The storage portion 4a is an information storage function block provided in the authentication server 4. The storage portion 4a is built-in or externally connected to the authentication server 4. The storage portion 4a has an information storage function, such as a magnetic storage medium or a semiconductor memory, wherein the storage portion 4a stores, for example, information which is inputted through the intra-system network 9 and information received through the network 10 and/or a leased line. The processor portion 4b is a computing operation function block provided in the authentication server 4. The processor portion 4b has the CPU (central processing unit) thereby to perform information processing in response to the input of information transmitted through the network 10 and/or leased line. In addition, the processor portion 4b performs information processing in response to information which is input through the intra-system network 9. The processor portion 4b issues an instruction to the storage portion 4a to execute information updating in relation with the information processing executed by the processor portion 4b itself. In response to the instruction, the storage portion 4a updates information being stored.

The management unit terminal 5 is an information processing terminal capable of executing electronic processing on input information. The management unit performs tasks such as format checking on claim reports transmitted from the sales side, and makes determination of an analysis unit suitable to perform the analysis of the claim reports. In a configuration wherein a plurality of management unit exists in the management/analysis side 1, at least one management unit terminal 5 is provided in each of the management units. In this case, the each of the management unit terminals 5 is capable of sharing information with each other. The management unit terminal 5 has an input portion 51, a storage portion 52, a processing portion 53, a display portion 54, and a communication portion 55.

The input portion 51 is an information input function block provided in the management unit terminal 5. The management unit terminal 5 has information input functions such as a keyboard capable of inputting characters, a sound collecting unit (microphone) capable of inputting sound (audio information), and a touch panel provided to a display screen. The input portion 51 connects to the processing portion 53, wherein information entered from the input portion 51 is outputted to the processing portion 53. The input portion 51 further connects to the storage portion 52, whereby information inputted from the input portion 51 is outputted to the storage portion 52 as well.

The storage portion 52 is an information storage function block provided in the management unit terminal 5. The storage portion 52 is built-in or externally connected to the management unit terminal 5. The storage portion 52 has an information storage function, such as a magnetic storage medium or a semiconductor memory, wherein the storage portion 52 stores, for example, information inputted from the input portion 51 and information received through the network 10 and/or leased line.

The processing portion 53 is a computing operation function block provided in the management unit terminal 5. The processing portion 53 has the CPU (central processing unit) thereby to perform information processing in response to the input of information transmitted through the network 10 and/or leased line. The processing portion 53 performs information processing in response to the input of information from the input portion 51. The processing portion 53 issues an instruction to the storage portion 52 to execute information updating in relation with the information processing executed by the processing portion 53 itself. In response to the instruction, the storage portion 52 updates information being stored.

The display portion 54 is an information display function block provided in the management unit terminal 5. The display portion 54 has, for example, a display having a display screen, and a speaker performing audio outputting. The management unit terminal 5 reports through the display portion 54 predetermined information to staffs of the management unit using the management unit terminal 5.

The communication portion 55 is a communication control function block provided in the management unit terminal 5. The communication portion 55 has a communication interface for performing information communication. The communication portion 55 inputs and/or outputs information transmitted and/or received through the communication interface. Additionally, the communication portion 55 receives, through the communication interface, information transmitted through the network 10 and/or leased line. The communication portion 55 is connected to the intra-system network 9 provided in the system, thereby to perform information communication with the analysis unit terminal 6 through the intra-system network 9.

The analysis unit terminal 6 is an information processing terminal provided in the analysis unit. The analysis unit performs analysis operation corresponding to a plurality of claim reports sent from the sales side. In a configuration wherein a plurality of analysis unit exists in the management/analysis side 1, at least one analysis unit terminal 6 is provided in each of the analysis units. In this case, each of analysis unit terminals 6 is capable of sharing information with each other. The analysis unit terminal 6 has an input portion 61, a storage portion 62, a processor portion 63, a display portion 64, and a communication portion 65.

The input portion 61 is an information input function block provided in the analysis unit terminal 6. The input portion 61 has an information input function similar to that of the input portion 51 of the management unit terminal 5. The storage portion 62 is an information input function provided in the analysis unit terminal 6. The storage portion 62 has an information storage function similar to the storage portion 52 of the management unit terminal 5. The processor portion 63 is a computing operation function block provided in the analysis unit terminal 6. The processor portion 63 has a function similar to that of the processing portion 53 of the management unit terminal 5. The display portion 64 is an information display function block provided in the analysis unit terminal 6. The display portion 64 has an information display function similar to that of the display portion 54 of the management unit terminal 5. The communication portion 65 is a communication control function block provided in the analysis unit terminal 6. The communication portion 65 has an information communication function as that of the communication portion 55 of the management unit terminal 5. The communication portion 65 is connected to the intra-system network 9 provided in the system, thereby to perform information communication with the management unit terminal 5 through the intra-system network 9.

The first sales side terminal 7 is an information processing terminal provided in a sales dealer not provided with a leased line between itself and the management/analysis side 1. The first sales side terminal 7 has an input portion 71, a storage portion 72, a processor portion 73, a display portion 74, and a communication portion 75. The input portion 71 is an information input function block provided in the first sales side terminal 7. The input portion 71 has an information input function similar to that of the input portion 51 of the management unit terminal 5. The storage portion 72 is an information storage function block provided in the first sales side terminal 7. The storage portion 72 has an information storage function similar to that of the storage portion 52 of the management unit terminal 5. The processor portion 73 is a computing operation function block provided in the first sales side terminal 7. The processor portion 73 has a function similar to that of the processing portion 53 of the management unit terminal 5. The display portion 74 is an information display function block provided in the first sales side terminal 7. The display portion 74 has an information display function similar to that of the display portion 54 of the management unit terminal 5. The communication portion 75 is a communication control function block provided in the first sales side terminal 7. The communication portion 75 has an information communication function similar to that of the communication portion 55 of the management unit terminal 5. The communication portion 75 is connected to the network 10, thereby to perform information communication with the management/analysis side 1 through the network 10.

The second sales side terminal 8 is an information processing terminal provided in a sales dealer provided with a leased line between itself and the management/analysis side 1. The second sales side terminal 8 has an input portion 81, a storage portion 82, a processor portion 83, a display portion 84, and a communication portion 85. The input portion 81 is an information input function block provided in the second sales side terminal 8. The input portion 81 has an information input function similar to that of the input portion 51 of the management unit terminal 5. The storage portion 82 is an information storage function block provided in the second sales side terminal 8. The storage portion 82 has an information storage function similar to that of the storage portion 52 of the management unit terminal 5. The processor portion 83 is a computing operation function block provided in the second sales side terminal 8. The processor portion 83 has a function similar to that of the processing portion 53 of the management unit terminal 5. The display portion 84 is an information display function block provided in the second sales side terminal 8. The display portion 84 has an information display function similar to that of the display portion 54 of the management unit terminal 5. The communication portion 85 is a communication control function block provided in the second sales side terminal 8. The communication portion 85 has an information communication function as that of the communication portion 55 of the management unit terminal 5. The communication portion 85 is connected to the leased line connecting to the management/analysis side 1, thereby to perform information communication with the management/analysis side 1 through the leased line.

The intra-system network 9 is provided in the management/analysis side 1. The intra-system network 9 is constituted of communication lines having a predetermined security level, and is used for information communication mutually among a plurality of devices provided in the system. In addition, the intra-system network 9 is connected to the network 10 and the leased lines. A plurality of first sales side terminals 7 and second sales side terminals 8 provided in the sales side perform information communication to the management/analysis side 1 through the network 10, the leased lines and the intra-system network 9.

The network 10 is an information communication network connected to each of the management/analysis side 1 and the sales side. As is represented by the Internet, the network 10 has wide area communication lines (network), thereby to solve the geographical disadvantage on a plurality of sales dealers connecting to the management/analysis side 1.

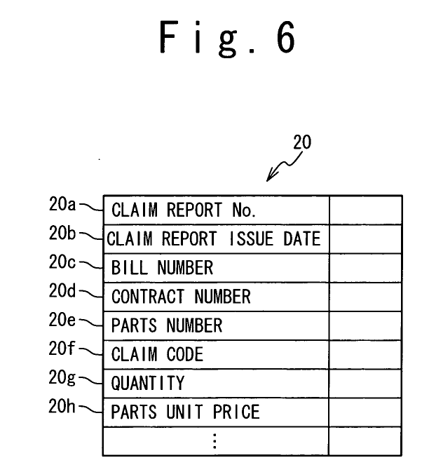

FIG. 6 is a diagram showing a claim report 20 to be stored in the first server 3. Referring to FIG. 6, the claim report 20 includes a claim report No. 20a, a claim report issue date 20b, a bill number 20c, a contract number 20d, a parts number 20e, a claim code 20f, a quantity 20g, and a parts unit price 20h and so on. The claim report number 20a indicates an identification/filing number of a claim report created through either the first sales side terminal 7 or second sales side terminal 8. The claim report is given an appropriate number from the system in the order of generation. The claim report number 20a is that given number. The claim report issue date 20b indicates the date and time of the generation of the claim report. Ordinarily, as the claim report issue date 20b, date and time corresponding to the date and time of a timepiece provided in the system is written in the claim report in response to the generation of the claim report. The bill number 20c indicates a bill number accompanying the parts causing the generation of the claim report. In the case that the claim report is on a grievance on the parts ordered by the sales dealer, a bill accompanies the parts delivered corresponding to the order. The bill number 20c indicates an identification/filing number given to the bill.

The contract number 20d is an identification/filing number indicating a contractual relationship effected upon the conclusion of a contract between the sales dealer and the manufacturer. This number is given in such a case that a sales contract for the parts are concluded between the sales dealer and the manufacturer. This number is set unique to the sales dealer. With the contract number 20d, the manufacturer can identify the sales dealer that has generated the claim report. The parts number 20e is indicated by using a code representing the state of an occurred defect. The sales dealer classifies the type of an imposed grievance depending on what kind of defects cause the grievance by using the parts number 20e, and notifies the result to the manufacturer. Based on the parts number 20e, the manufacturer dealer acquires the contents of the grievance (claim). The claim code 20f indicates the quantity of defect-occurring parts. Generally, parts order is made in units of a plurality of pieces. The claim code 20f indicates the quantity of defect-occurring parts of that plurality of pieces. The parts unit price 20h indicates a retail unit price in the case that the manufacturer actually makes a retail delivery of parts to the sales dealer. The system is capable of calculating a new bill amount corresponding to the parts unit price 20h. This makes it possible to set an appropriate sales amount corresponding to the grievance.

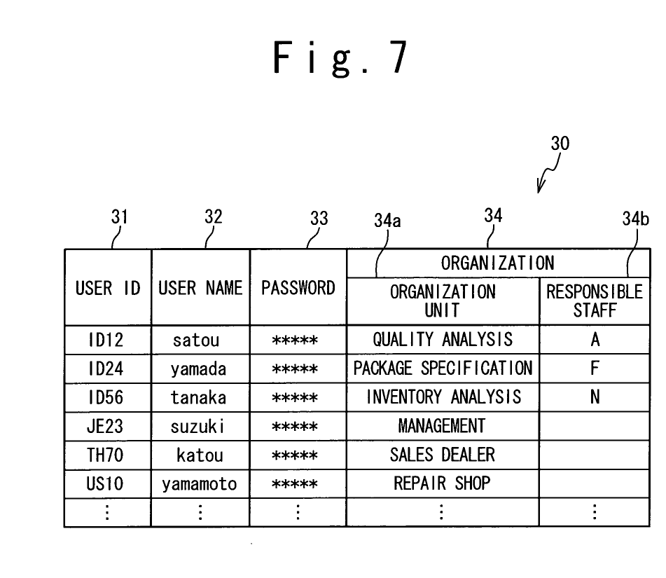

FIG. 7 is a diagram showing the configuration of an authentication table 30 stored in the authentication server 4. With reference to FIG. 7, the authentication table 30 includes at least a user ID 31, a user name 32, a password 33, and an organization 34. The organization includes an organization unit 34a and a responsible staff 34b. The user ID 31 indicates an ID of a user permitted to access the system. The system allocates the ID to each of a plurality of users in one-to-one correspondence. The authentication table 30 stores the ID into the user ID 31. The user name 32 is the name of the access-permitted user with respect to the system. The system allocates to the respective user a system-use name used to identify the respective user. The user name 32 is allocated the system user in one-to-one correspondence. The user ID 31 and the user name 32 are one-to-one related. The password 33 is a password playing the role of a key when the system user logs in to the system. The password 33 is changed or changeable to a setup change by a system administrator. The user owning a password-changing authority for the password 33 is arbitrarily changeable. The encrypted passwords 33 are stored in the authentication table 30. The organization-unit 34 indicates an organization to which a respective user belongs. The field of the organization unit 34 stores information of the organization unit 34a and the staff 34b. The organization unit 34a indicates the name of an organization unit to which a respective user belongs. In the case that the organization has an expert field, the field of the responsible staff 34b stores information of the expert field.

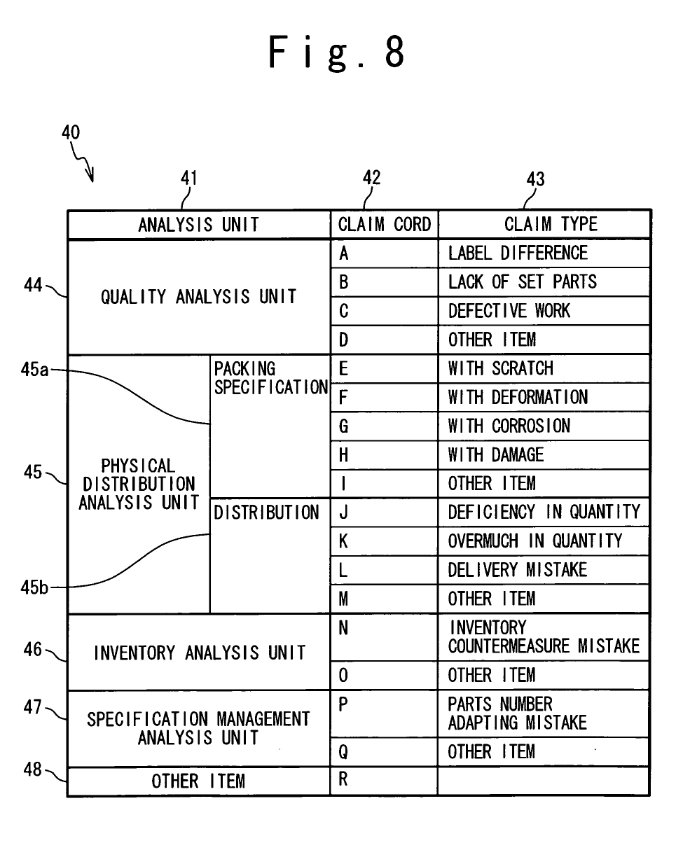

FIG. 8 is a diagram showing a claim analysis table 40 stored in the main server 2. Referring to FIG. 8, the claim analysis table 40 includes at least an analysis unit 41, a claim cord 42, and a claim type 43. The analysis unit 41 indicates an analysis unit that conducts for analysis of defect occurrence causes. The claim cord 42 indicates an encoded claim type. The claim type 43 indicates a detail of a defect. The analysis unit 41 has a quality analysis unit 44, a physical distribution analysis unit 45, an inventory analysis unit 46, a specification management analysis unit 47, and an other item 48. The quality analysis unit 44 indicates an organization unit that performs analysis in the event that an occurring defect relates to parts quality. The physical distribution analysis unit 45 indicates an analysis unit that performs analysis in the event that a parts defect is caused by physical distribution. The physical distribution analysis unit 45 has a packing specification 45a and a distribution 45b. The packing specification 45a indicates an organization unit that performs analysis in the event that an occurring defect relates to parts packing. The distribution 45b represents an analysis unit that performs analysis in the event that an occurring defect relates to parts distribution. The inventory analysis unit 46 indicates an analysis unit that performs analysis in the event that an occurring defect relates to a parts inventory state. The specification management analysis unit 47 indicates an analysis unit that performs analysis in the event that an occurring defect relates to parts specification management. The claim analysis table 40 stores claim cords 42 and claim types 43 corresponding to the respective analysis units.

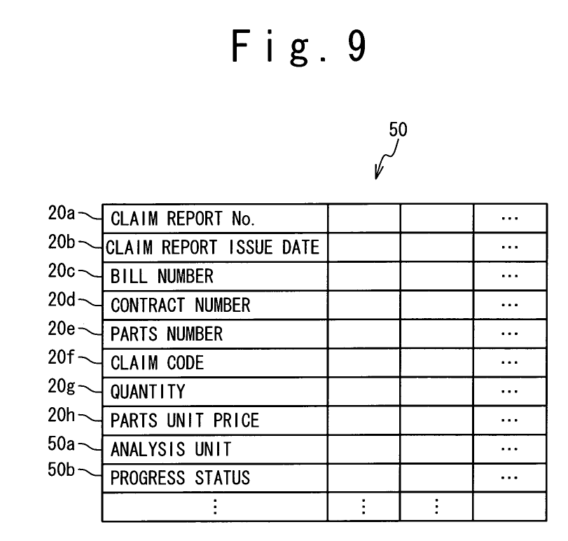

FIG. 9 is a diagram showing the configuration of a claim report management table 50 stored in the main server 2. Referring to FIG. 9, the claim report 50 includes a claim report No. 20a, a claim report issue date 20b, a bill number 20c, a contract number 20d, a parts number 20e, a claim code 20f, a quantity 20g, a parts unit price 20h, a analysis unit 50a, and a progress status 50b. Each of data of the claim report No. 20a to the parts unit price 20h of the claim report 20 transmitted from the first server 3 is stored correspondingly to the claim report No. 20a to the parts unit price 20h of the claim report management table 50. The claim report management table 50 stores a plurality of claim reports 20 in the form of the table. The analysis unit 50a indicates an analysis unit that actually performs analysis of a specific claim report. The progress status 50b indicates information of, for example, how analysis of the specific claim report has progressed.

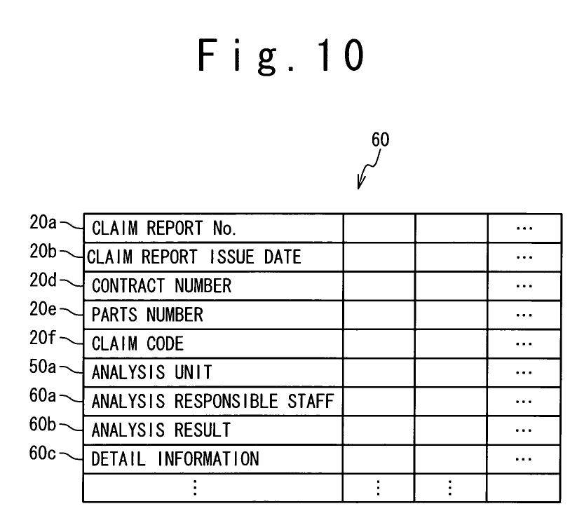

FIG. 10 is a diagram showing the configuration of an analysis result table 60 stored in the main server 2. The analysis result table 60 is updated (or newly created) in response to receipt of analysis data transmitted from the analysis unit terminal 6. Referring to FIG. 10, the diagnosis result table 60 includes at least a claim report No. 20a, a claim report issue date 20b, a contract number 20d, a parts number 20e, a claim code 20f, a analysis unit 50a, a analysis responsible staff 60a, a analysis result 60b, and detail information 60c. The fields of the claim report No. 20a to the analysis unit 50a stores values same as those of the claim report management table 50 in correspondence thereto. The analysis responsible staff 60a to the detail information 60c are stored based on the analysis data transmitted from the analysis unit terminal 6. The analysis responsible staff 60a stores information that is used to specify a analysis responsible staff who has transmitted the analysis data. The field of the analysis result 60b stores the transmitted analysis result. In the event that further detailed information is added to the analysis result, the information is stored in the field of the detail information 60c.

### Operation of the Second Embodiment

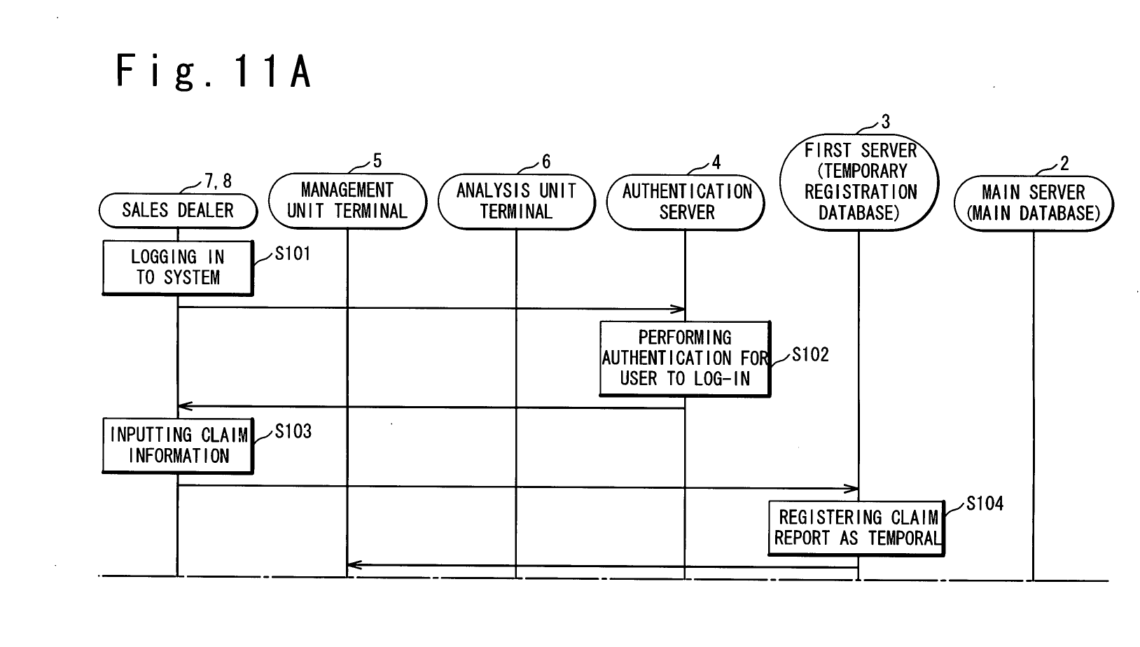

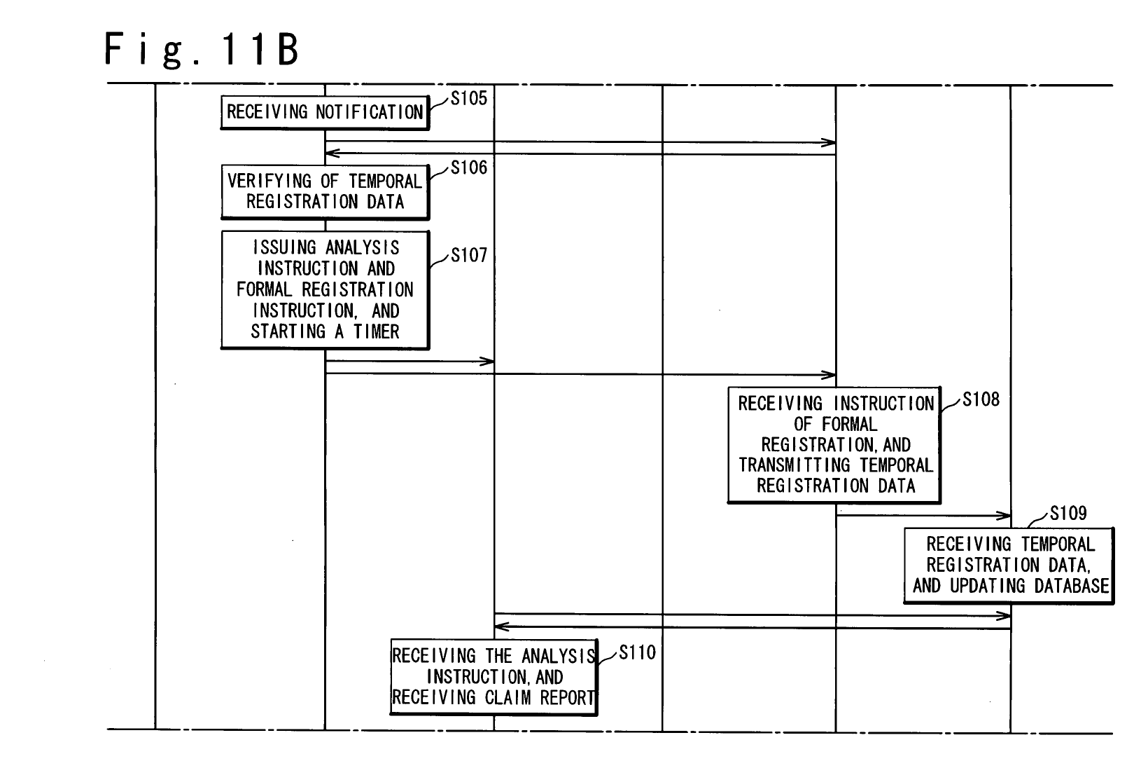

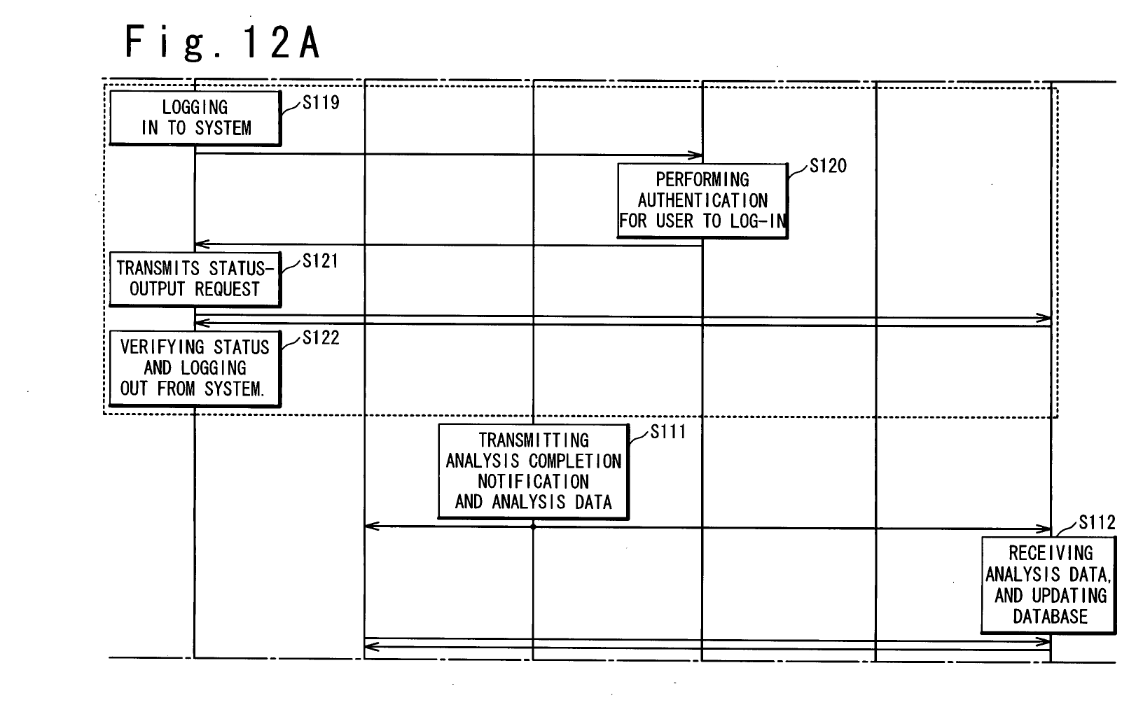

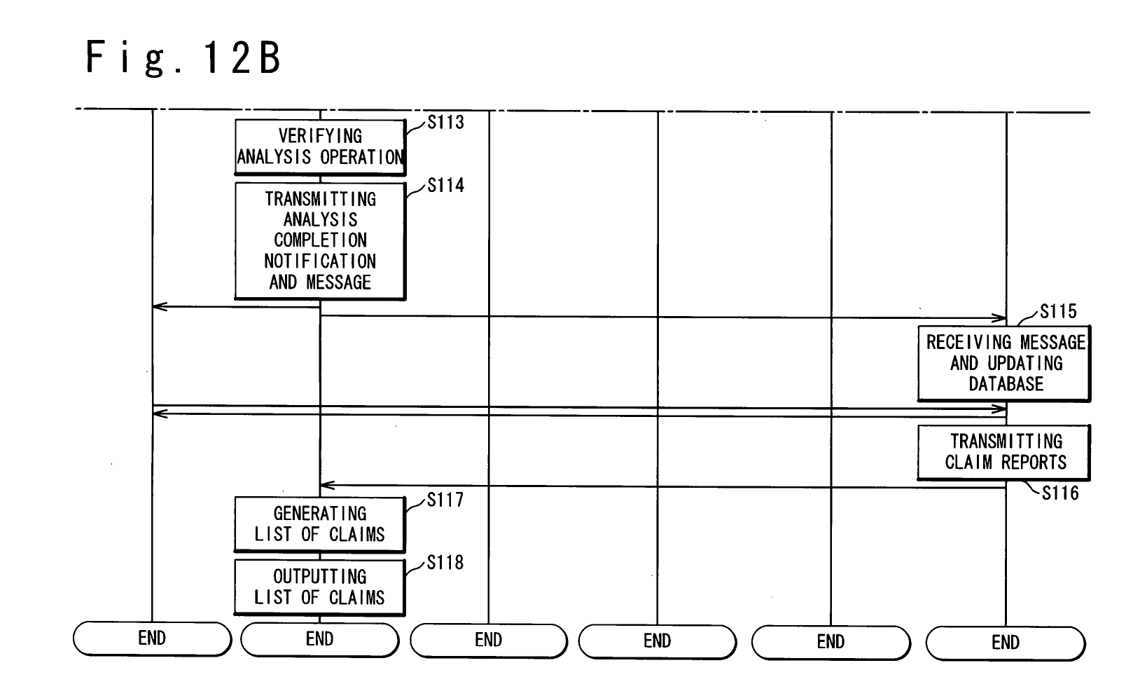

FIGS. 11A, 11B, 12A and 12B are sequence charts illustrating an operation of the system according to the second embodiment. The system operation starts with occurrence of a claim on a product on a sales dealer. The sequence shown in FIGS. 11A, 11B, 12A and 12B illustrates a case where no feedback occurs in the operation according to the present embodiment. FIGS. 11A and 11B show the first half of the operation, and FIGS. 12A and 12B shows the latter half of the operation. Referring to FIGS. 11A and 11B, in the step S101 the sales dealer performs a log-in operation to the system through the network 10 or leased line. The login operation is performed in the manner that a responsible staff member enters his or her own user ID and password by using the first sales side terminal 7 (or the second sales side terminal 8). The entered user ID and password are transmitted to the authentication server 4 through the network 10 or leased line.

In the step S102, the authentication server 4 performs authentication by determining whether the user ID and the password are valid. If a valid user ID and password has been entered, the authentication server 4 permits the terminal to log-in to the system. In the step S103, the responsible staff of the sales dealer inputs claim information. The information is inputted from the first sales side terminal 7 (or the second sales side terminal 8) that has completed log-in to the system. The first sales side terminal 7 (or the second sales side terminal 8) transmits the input-completed claim information as a claim report 20 to the first server 3.

In the step S104, the first server 3 stores the transmitted claim report 20 as temporal registration data, in the storage portion 3a and then transmits a storage completion notification for the claim report 20 to the management unit terminal 5. The management unit terminal 5 receives the storage completion notification from the first server 3, which shows the transmission of the claim report 20 (the step S105).

In the step S106, in response to the storage completion notification, the management unit terminal 5 obtains the claim report 20 and performs a verification of the claim report 20 stored in the first server 3. In the verification, if no format defectiveness is recognized in the claim report 20, a selection/determination operation is performed to select an analysis unit suitable to perform the analysis of the claim report 20. In the step S107, the management unit terminal 5 issues an analysis instruction for analyzing the claim report 20 to the analysis unit determined through the selection/determination operation. Concurrently, the management unit terminal 5 issues an instruction to the first server 3 to transmit the temporal registration data to the main server 2. Further, at this time point, the management unit terminal 5 sets a time limit of completion of outputting of an analysis completion notification.

In the step S108, having received the instruction of the transmission for the temporal registration data from the management unit terminal 5, the first server 3 transmits to the main server 2 the temporal registration data stored in the storage portion 3a. In the step S109, the main server 2 receives the temporal registration data, and performs updating of the database in response to the reception. In this event, the main server 2 updates the progress status 50b in the claim report management table 50 to information indicative of an analysis-in-progress status.

In the step S110, having received the analysis instruction, the analysis unit terminal 6 issues a request to the main server 2 for the claim report information corresponding to that instruction. In response to the request, the main server 2 searches the database and sends the stored claim report information as a response. The analysis unit terminal 6 executes the analysis operation corresponding to the claim report information transmitted as the response.

In the step S111, in response to analysis completion, the analysis unit terminal 6 transmits an analysis completion notification to the management unit terminal 5. In addition, the analysis unit terminal 6 transmits analysis data related to the claim report. In the step S112, the main server 2 receives the transmitted analysis data. In response to the reception, the main server 2 updates the analysis result table 60 stored in the database. In this event, the main server 2 updates the progress status 50b in the claim report management table 50 to information indicative of the analysis completion.

In the step S113, in response to the received analysis completion notification, the management unit terminal 5 issues a request the main server 2 for the analysis data. In response to the request, the main server 2 extracts the claim treatment result from the analysis result table 60 and transmits it to the management unit terminal 5. In response to the request, the management unit terminal 5 receives the claim treatment result transmitted from the main server 2, and executes a verification whether the analysis operation has been appropriately performed. In the step S114, the management unit terminal 5 transmits an analysis completion notification to the first sales side terminal 7 (or the second sales side terminal 8). Concurrently, the management unit terminal 5 transmits to the main server 2 a message notifying of completion of the verification with respect to the claim treatment result.

In the step S115, the main server 2 receives the message transmitted from the management unit terminal 5, and executes updating of the database in response to the reception. The updating completes the overall processing for the claim report 20. Upon receipt of the analysis completion notification, the first sales side terminal 7 (or the second sales side terminal 8) issues a request to the main server 2 for an output of a final result on the claim report 20 corresponding to the analysis completion notification. Upon receipt of the request, the main server 2 outputs information corresponding to the request, and transmits the information to the first sales side terminal 7 (or the second sales side terminal 8).

In the S116, in correspondence to passage of a specific time, the main server 2 extracts from the claim report management table 50 a claim report(s) 20 stored within the specific time in the storage portion 2a, and transmits it to the management unit terminal 5. In the step S117, based on the transmitted claim report, the management unit terminal 5 generates a list enabling verification of what type of a claim has occurred for each item, and stores it into the storage portion 52. Such a list is used when, for example, a time is necessary for an accounting process since a claim occurs on the parts once delivered. In the step S118, such a list stored in the storage portion 52 is outputted to another management unit terminal 5 requesting for the list. Responsible staff members and the like of individual analysis units can quickly acquire the status of other organization units by viewing the list.

A portion of the operation from the steps S119 to S122 (portion surrounded by a dotted line) indicates a sequence that the first sales side terminal 7 (or the second sales side terminal 8) verifies the progress status relating to the analysis of a claim report through the network 10. In the step S119, the sales dealer performs a login operation to the system through the network 10 or leased line. The login operation is performed in the manner that a responsible staff member enters his or her own user ID and password by using the first sales side terminal 7 (or the second sales side terminal 8). The entered user ID and password are transmitted to the authentication server 4 through the network 10 or leased line.

In the step S120, the authentication server 4 performs authentication by determining whether the user ID and the password are valid. If the valid user ID and password has been entered, the authentication server 4 permits the terminal to log-in to the system.

In the step S121, the first sales side terminal 7 (or the second sales side terminal 8), which has logged-in to the system, transmits a status-output request of a predetermined claim report to the main server 2. The main server 2 extracts from the claim report management table 50, a progress status of a claim report corresponding to information such as a claim report No. contained in the request, and transmits the status as a response. In the step S122, the user who has completed the verification of the status logs out from the system.

This can improve the claim-report processing speed, and enable to avoid problem occurrence resulted from a processing delay. In addition, the above-described process makes it possible to facilitate a status verification on an issued claim report. The status verification can be executed any time from the first sales side terminal 7 (or the second sales side terminal 8), so that the sales dealer can generate appropriate task schedules subsequent to the claim report generation.

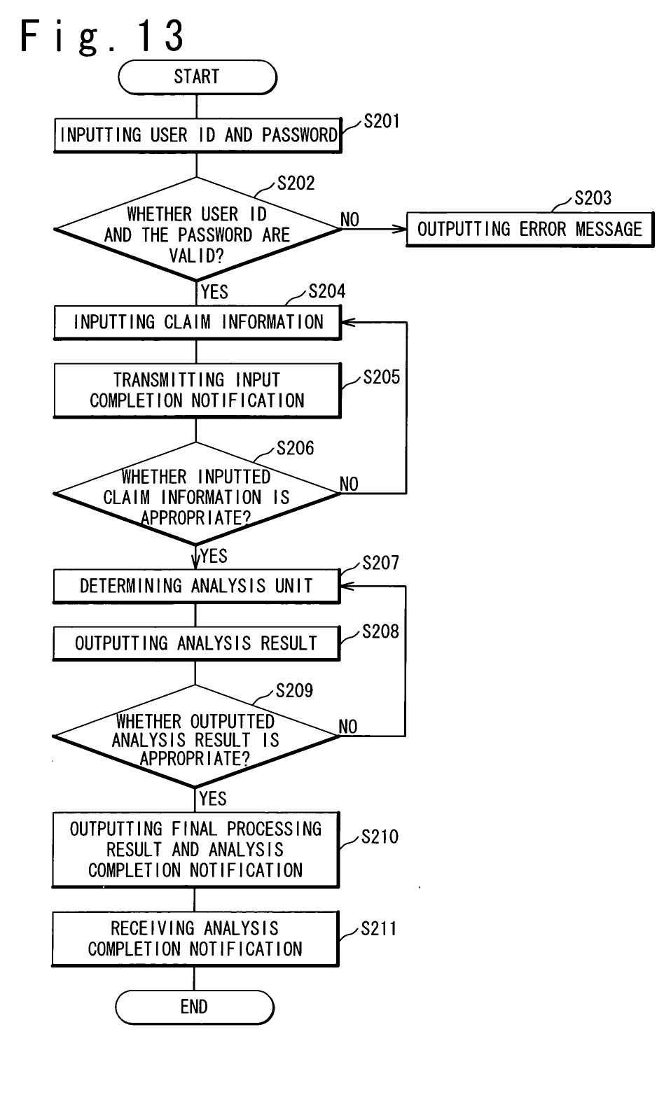

FIG. 13 is a flowchart illustrating operation executed in the case that a claim on the parts occurs in a sales dealer connected to the network 10 or leased line. The operation covers the steps of from transmission of the claim to the notification of analysis completion to the sales dealer. The operation shown in FIG. 13 starts when a user using a first sales side terminal 7 (or a second sales side terminal 8) on the sales side inputs the user ID 31 and the password 33 allocated to himself or herself. The following will make a description by reference to an example case where information communication is performed between the first sales side terminal 7 and management/analysis side 1 connected to the network 10.

In the step S201, the user, who uses the first sales side terminal 7, causes the display portion 74 to display a screen for logging in to the system by inputting the user ID 31 and the password 33 from the input portion 71.

In the step S202, in response to input completion, the authentication server 4 executes a password authentication. The password authentication is executed based on the claim analysis table 40. The authentication server 4 determines from the input user ID 31 and the password 33 whether the corresponding user exists in the claim analysis table 40. As a result, if the valid user ID 31 and the password 33 are not inputted, the authentication server 4 outputs an error to the first sales side terminal 7 (the step S203).

If the input user ID 31 and the password 33 are valid, the processing proceeds to the step S204. In the step S204, the user inputs the claim information by using the first sales side terminal 7 logged in to the system. In the step S205, the first sales side terminal 7 transmits an input completion notification (claim occurrence notification) to the management unit terminal 5, which has completed inputting of the upper portion.

In the step S206, the management unit terminal 5 verifies the claim occurrence in response to the reception of the input completion notification, and reads a claim report 20 corresponding to the notification from the database of the first server 3. A management staff using the management unit terminal 5 makes determinations of, for example, whether the read-in claim report 20 contains appropriate information and whether information defectiveness has not occurred. As a result, if appropriate information has not been transmitted from the first sales side terminal 7, the management unit terminal 5 transmits an information re-input request to the first sales side terminal 7 through the network 10 (returns to the step S204). If the appropriate information has been inputted, the processing proceeds to the step S207 to execute a determination operation for a analysis unit. In the S207, as a result of the determination operation for an analysis unit, if an organization unit for performing the analysis has been determined, the management unit terminal 5 adds information of the analysis unit to the claim report 20, and transmits the claim report 20 to the main server 2. Concurrently, the management unit terminal 5 issues an analysis instruction to the analysis unit terminal 6. In response to the instruction, the analysis unit outputs the corresponding claim report 20 from the claim report management table 50, and executes the analysis operation.

In the step S208, the analysis unit terminal 6 having completed the analysis operation transmits an analysis completion notification to the management unit terminal 5. Concurrently, the analysis unit terminal 6 transmits analysis data to the main server 2. Based on the transmitted data, the main server 2 updates the claim report management table 50. In addition, the main server 2 generates an analysis result table 60 based on the transmitted analysis result, and stores the generated analysis result table 60.

In the step S209, having received the analysis completion notification, the management unit terminal 5 outputs a corresponding analysis result from the analysis result table 60, which has been stored into the main server 2. The management staff using the management unit terminal 5 determines whether the output analysis result is appropriate. As a result, if the analysis result is inappropriate (when an-apparent misunderstanding exists), the processing returns to the step S207 whereby to perform a re-research process of the analysis unit. If the analysis is appropriately performed, processing proceeds to S210. In the step S210, the management unit terminal 5 transmits a final processing result on the claim report to the main server 2. Concurrently, the management unit terminal 5 transmits an analysis completion notification to the first sales side terminal 7 having generated the claim report. In the step S211, having received the notification transmitted from the management unit terminal 5, the first sales side terminal 7 logs in to the system, and receives a corresponding final processing result from the main server 2.

This makes it possible to significantly reduce the time necessary for processing tasks for the claim report. With the reduction in the time necessary for the processing tasks, costs such as labor costs used in the past can be reduced.

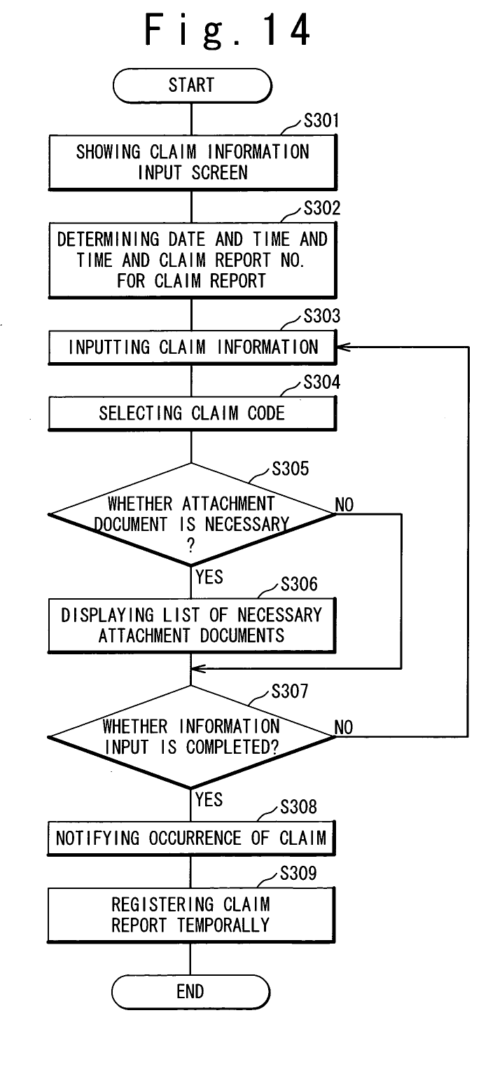

The information input operation described in conjunction with S204 of FIG. 13 will be described in more detail here. FIG. 14 is a flowchart illustrating an operation that a responsible staff dealing with a customer in a sales dealer inputs claim information to the first sales side terminal 7. The operation shown in FIG. 14 starts after the responsible staff activates the first sales side terminal 7 thereby to logs in to the system. In the S301, the responsible staff makes the display section 74 show a claim information input screen by using the first sales side terminal 7.

In the step S302, having displayed the claim information input screen, the first sales side terminal 7 determines a date and time for generation of the claim report by using the timepiece provided to the system, and adds it as the claim report issue date 20b to the claim information. In addition, the first sales side terminal 7 generates the claim report No. based on a predetermined rule, and adds it as the claim report No. 20a to the claim information.

In the step S303, the claim information is inputted. The claim information input screen has an input field corresponding to a claim report 20, wherein the input field becomes active in response to completion of inputting of the previous item. Thereby, an item-input defectiveness can be prevented. In the step S304, a selection is made for the claim code 20f. In this case, the claim information input screen displays a screen corresponding to the claim cord 42/claim type 43 of the claim analysis table 40. Inputting of the claim code 20f is completed by selecting a code from the screen. Thereby, the burden on an inputting operator can be reduced, and inputting of an incorrect parts number 20e can be prevented.

In the step S305, the first sales side terminal 7 determines whether an attachment document is necessary for the inputted claim code 20f. If no attachment document is necessary, the processing proceeds to S307. If the attachment document is necessary for the inputted claim information, the claim information input screen displays a list of necessary attachment documents in response to the completion of inputting of the claim code 20f (the step S306). Thereby, an accident with, for example, no necessary document being attached can be prevented.

In the step S307, the first sales side terminal 7 determines whether inputting of the information has been completed. Upon completion of the inputting of the information, the responsible staff performs a transmitting operation to transmitting the claim information to the first server 3. In response to the transmitting operation, the first sales side terminal 7 verifies inputted items. If a defectiveness is found with the input items, the first sales side terminal 7 requests for re-inputting. According to the operation shown in FIG. 14, whereas the operation is shown to be performed in the event that the processing returns to the step S304, the present invention does not limit this re-input request operation. For example, the operation may return to one of the steps S303 to S306.

In the step S308, if no defectiveness is found in the inputted claim information, the first sales side terminal 7 notifies the management unit terminal 5 that the claim report has been generated. In addition, the first sales side terminal 7 transmits the claim information as a claim report 20 to the first server 3. In the step S309, the first server 3 stores the claim report 20, which has been transmitted from the first sales side terminal 7, into the storage portion 3a.

According to the operation described above, the time and labor necessary for the claim report generation can be significantly reduced. Further, the terminal displays the input items by accessing the database, so that also possible errors in input operation can be prevented.

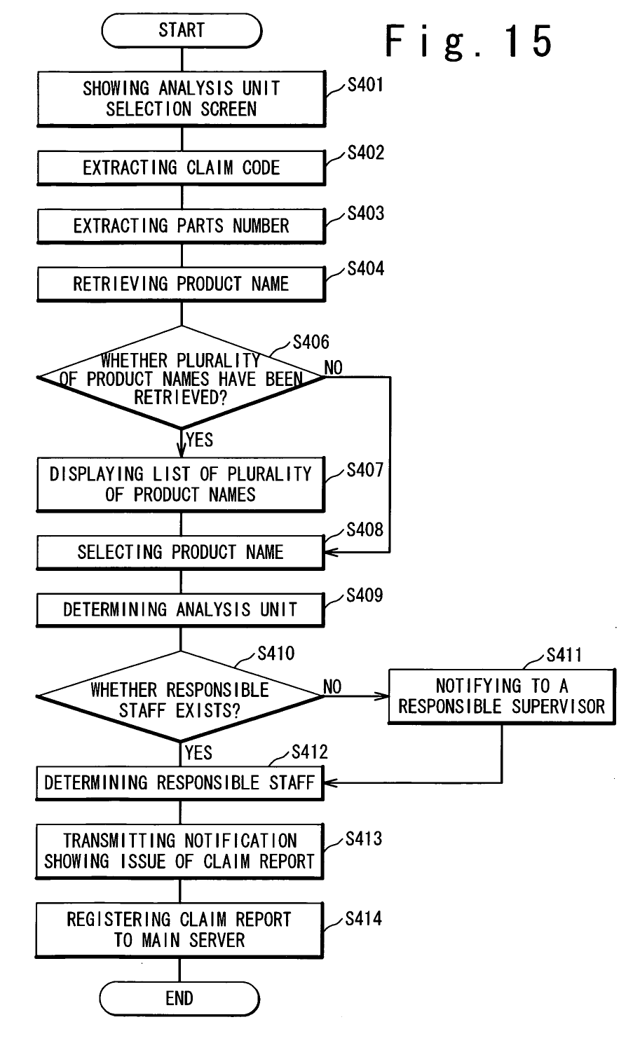

The operation described in conjunction with S207 in FIG. 13 will be described in more detail here. FIG. 15 is a flowchart illustrating operation that a responsible staff of the management unit determines a analysis unit. The operation of the analysis unit determination starts after the management unit terminal 5 is activated thereby to log in to the system. In the step S401, having received the claim occurrence notification in the management unit terminal 5, the responsible staff makes the display section 54 to show a analysis unit selection screen by using the management unit terminal 5.

In the step S402, the management unit terminal 5 reads from the storage portion 3a of the first server 3, a claim report 20 corresponding to the claim occurrence notification, and extracts a claim code 20f written in the claim report 20. Upon extraction of the claim code 20f, the management unit terminal 5 temporarily executes a selection of a analysis unit based on the claim analysis table 40 stored in the main server 2.

In the step S403, the management unit terminal 5 extracts a parts number 20e written in the claim report 20. In the step S404, the management unit terminal 5 retrieves product names corresponding to the extracted parts number 20e. The table configured of parts numbers 20e and product name corresponding to the parts numbers 20e is stored in the main server 2. The management unit terminal 5 retrieves the product names by accessing the table through the main server 2.

In the step S406, the management unit terminal 5 determines whether a plurality of product names have been retrieved corresponding to the extracted parts number. As a result, if a single product name has been retrieved, the processing proceeds to the step S408. If a plurality of product names has been retrieved, the management unit terminal 5 displays a list of the plurality of product names (the step S407). Alternatively, if no corresponding product name has been retrieved, the management unit terminal 5 displays an error message showing to that fact. In the step S408, the management unit terminal 5 selects a product name corresponding to the extracted parts number.

In the step S409, the management unit terminal 5 determines an analysis unit 41, to which an analysis instruction is finally issued, based on the selected product name and the claim code 20f. In the step S410, the management unit terminal 5 determines whether a responsible staff who analyzes the claim report 20 read from the first server 3 is present in the determined analysis unit. The determination is executed based on the authentication table 30 and the claim analysis table 40 stored in the authentication server 4. If, as a result of the determination, no responsible staff exists, a notification is issued to a responsible supervisor of that analysis unit (the step S411). The responsible member can assign the responsible staff. If the responsible staff exist, the processing proceeds to the step S412, whereby to execute the determination of the responsible staff.

In the step S413, the management unit terminal 5 transmits to the responsible staff, a notification showing that the issue of the claim report and the analysis instruction on that claim report. In the step S414, the management unit terminal 5 executes the operation of automatically register the claim report 20 in the first server 3 into the main server 2 in response to the transmission of the analysis instruction. In response to the reception of the claim report 20 transmitted from the first server 3, the main server 2 updates the claim report management table 50.

According to the operation described above, the responsible staff of the management unit can promptly specify the analysis unit, and the time necessary for the claim report processing tasks can be significantly reduced.

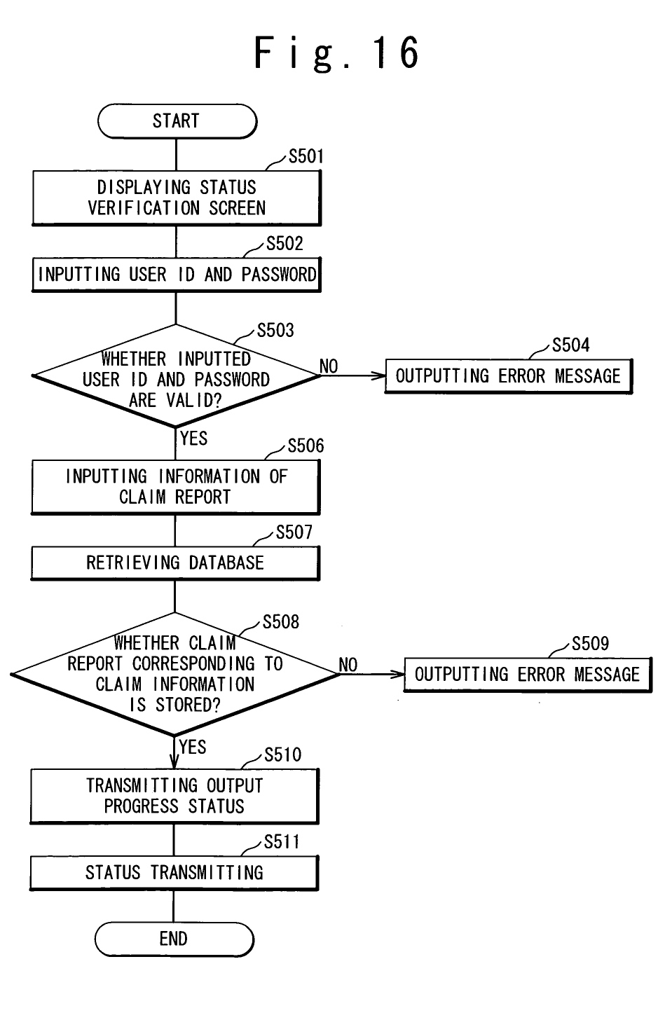

The following will describe, in more detail, the operation described in conjunction with the steps of from S119 to S122. FIG. 16 is a flowchart illustrating an operation that a responsible staff dealing with a customer in the sales dealer performs the verification of the status (progress status) of a claim report for which requesting for analysis has been completed. The operation of progress status verification shown in FIG. 16 starts when the status verification is necessary. In the step S501, the responsible staff makes the display section 74 display a status verification screen by using the first sales side terminal 7. In the step S502, the status verification screen displays an input field for the user ID 31 and the password 33. To log in to the system, the responsible staff inputs his or her user ID 31 and the password 33 from the input portion 71.

In the step S503, the first sales side terminal 7 determines whether the input user ID 31 and the password 33 are valid. In response to the completion of inputting of the user ID 31 and the password 33, the first sales side terminal 7 executes detects whether data corresponding to the authentication table 30 of the authentication server 4 has been registered. As a result, if a user ID and password corresponding to the input data cannot be detected, an error message is output (the step S504).

In the step S506, if the valid user ID 31 and the password 33 have been inputted, the first sales side terminal 7 displays a screen for inputting information for specifying the claim report for which the status verification is performed. Ordinarily, for the information for specifying the claim report, the claim report No. 20a is used. When it is difficult to specify the claim report No. 20a, the claim report is specified by other means wherein, for example, the claim report issue date 20b and the bill number 20c are combined and inputted.

In the step S507, the first sales side terminal 7 accesses the main server 2 to retrieve the claim report corresponding to the input claim information. In the step S508, the first sales side terminal 7 determines whether the claim report corresponding to the claim information is stored in the claim report management table 50. If, as a result, the corresponding claim report cannot be detected, an-error message is output (the step S509).

In the step S510, the first sales side terminal 7 issues a request to the main server 2 for a progress status 50b of the corresponding claim report. In response to the request, the main server 2 extracts the progress status 50b from the claim report management table 50 and outputs it. In the step S511, the main server 2 transmits the output progress status 50b to the first sales side terminal 7. The first sales side terminal 7 displays the received progress status 50b on the display portion 74.

The above-described status verification operation can be performed at the time during the steps of from claim report creation to the reception of a final processing result. This enables the sales dealer to appropriately generate task schedules subsequent to the claim report creation.

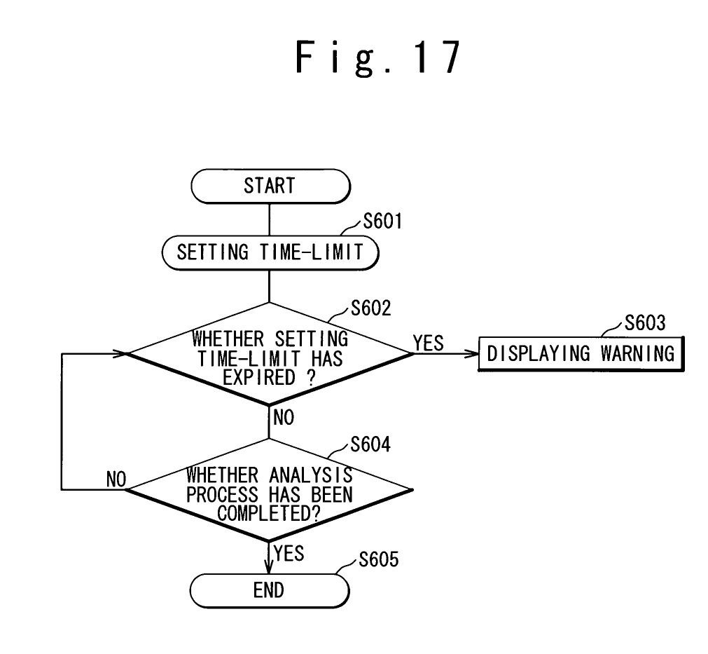

FIG. 17 is a flowchart illustrating an operation of time limit management according to the present embodiment. The present system specifies a number of days necessary in the period from the reception of a claim report to the analysis completion. When the specified days have passed before the analysis process completion, the system issues warning to the management staff, the analysis responsible staff, and the like. Thereby, the number of days required for the analysis process can be maintained substantially constant. To maintain the number of days to be substantially constant, the process-completion date and time can be estimated, thereby enhancing the degree of customer satisfaction.

In the step S601, when receiving a claim report from the first sales side terminal 7, the management unit terminal 5 executes time-limit setting, thereby to determine the date and time for issuing the warning. In the step S602, the management unit terminal 5 performs monitoring whether the set time limit has expired. The monitoring is performed on a round-the-clock basis, and warning display is performed when the time limit has expired (in the step S603).

in the step S604, the management unit terminal 5 performs a determination whether the analysis process has been completed. The detection is executed based on the claim report management table 50 of the main server 2. When the information of analysis completion is stored in the progress status 50b of the claim report management table 50, the management unit terminal 5 determines that the analysis process is completed. If the process has not yet been completed, the processing returns to S602. As a result of the determination, if the analysis process has been completed, the time-limit management operation is terminated.

According to the above description, whether or not tasks are delayed can be serially verified, and smooth claim report processing can be implemented. The time-limit setting can be changed as well corresponding to an arbitrary claim. For example, in an event needing a long time for the analysis process, an prolonged one is registered as a time limit to be set, whereby a plurality of different claim report processes can be promptly implemented.

The configuration and the operation of the second embodiment can be applied to those of the first embodiment within the range that does not include inconsistency.

1. A quality problem treatment supporting system comprising:
a temporary registration database which is operable to receive an e-mail from an e-mail sender including information with respect to a defect on a parts placing on the market, and to store said information as a temporal registration data;
a claim code database which is operable to store claim code data used to specify said defect;
a claim code checking section which is operable to extract a post-temporal registration claim code data from said temporal registration data read out from said temporary registration database, to retrieve said claim code database, and to determine whether a first claim code data corresponding to said post-temporal registration claim code data is stored in said claim code database;
a parts number database which is operable to store parts number data used to specify a parts in which a defect has occurred;
a parts number checking section which is operable to extract a post-temporal registration parts number data from said temporal registration data, to retrieve said parts number database, and to determine whether a first parts number data corresponding to said post-temporal registration parts number data is stored in said parts number database, when said first claim code data is stored in said claim code database;
an attached file search section which is operable to determine whether an attached image data is actually attached to said temporal registration data as an attached file of said e-mail, when said first parts number data is stored in said parts number database and it is necessary for said temporal registration data to have attached image data;
a temporal registration data determination section which is operable to determine whether said temporal registration data conforms to a predetermined rule to be appropriate;
a claim history database which is operable to store parts number data and claim history data, wherein said parts number data and said claim history data are related to each other;
a claim history data determination section which is operable to retrieve said claim history database, and to determine whether a first claim history data corresponding to said post-temporal registration parts number data is stored in said claim history database, when said temporal registration data is appropriate;
a delivery result database which is operable to store delivery result data indicating delivery results of parts corresponding to parts data;
a delivery result search section which is operable to retrieve said delivery result database, and to determine whether a first delivery result data indicating a delivery result of a parts corresponding to said post-temporal registration parts number data is stored in said delivery result database;
a classification data generation section which is operable to classify an occurrence cause of a defect corresponding to said temporal registration data which is appropriate based on said post-temporal registration claim code data extracted by said claim code checking section, and to generate a classification data, when said first delivery result data is stored in said delivery result database;
an investigation-execution-section determination section which is operable to determine an investigation execution section that investigates countermeasures on said occurrence causes, based on said classification data;
a formal registration execution section which is operable to register said temporal registration data as a formal registration data in a formal registration database;
a investigation request message generation section which is operable to generate an investigation execution request message indicating a request for investigation execution, and to send said investigation execution request message to said investigation execution section;
a countermeasure status database which is operable to store countermeasure status data indicating countermeasure statuses of past defects of said parts;
a past status determination section which is operable to extract said formal registration data from said formal registration database, to retrieve said countermeasure status database, to determine whether a countermeasure was executed in the past on a defect data same as a first defect data indicating said defect contained in said formal registration data, and to transmit a first countermeasure execution data indicating a new countermeasure submitted by said investigation execution section to said e-mail sender when said countermeasure was not executed;
a continuous failure determination section which is operable to determine whether said first defect data includes data with respect to a continuous failure, when said countermeasure was executed in the past on said first defect data, and to transmit a second countermeasure execution data indicating said countermeasure extracted from said countermeasure status database to said e-mail sender when said first defect data includes said data with respect to said continuous failure;
a post-processing data generation section which is operable to generate a post-processing data in which said formal registration data is related to said determination results by said past status determination section and said continuous failure determination section, and to store said post-processing data in said formal registration database;
a defect responsibility rate calculation section which is operable to calculate a defect responsibility rate based on said post-processing data;
a price database which is operable to store parts price data indicating market supply prices of parts corresponding to said parts number;
an expense database which is operable to store expense data indicating expenses when parts are supplied in the market;
a price data extraction section which is operable to retrieve said price database, and to extract a price data indicating a price of a first parts corresponding to a parts number included in said post-processing data;
an expense data extraction section which is operable to retrieve said expense database, and to extract an expense data indicating an market supply expense of said first parts;
a remuneration calculation section which is operable to calculate a remuneration data based on said defect responsibility rate, said price data and said expense data;
a monetary amount calculation section which is operable to calculate a monetary amount based on said remuneration data and an exchange rate;
a payment amount determination section which is operable to determine an actual payment amount based on said monetary amount; and
a monetary amount information transmission section which is operable to generate a payment notice message notifying said payment amount, and to transmit another e-mail including said payment notice message to a sender of said e-mail sender,
wherein said sender is enabled to execute one of said countermeasure and said new countermeasure in said countermeasure execution data to repair said defect.

2. The quality problem treatment supporting system according to claim 1, wherein said temporal registration data determination section generates an impropriety message, and transmits still another e-mail including said impropriety message to said sender of said e-mail, when said temporal registration data determination section determines said temporal registration data is not appropriate.

3. The quality problem treatment supporting system according to claim 1, wherein at least one of said past status determination section and said continuous failure determination section is operable to generate a post-countermeasure data indicating a countermeasure completion, and to store said post-countermeasure data, which is related to said parts number data included in said formal registration data, in said countermeasure status database, when said countermeasure was executed in the past on said first defect data.

4. A quality problem treatment supporting method, comprising the steps of:
(a) reading out a temporal registration data, which indicates information with respect to a defect on a parts placing on the market, from a temporary registration database;
(b) extracting a post-temporal registration claim code data from said temporal registration data, retrieving a claim code database storing claim code data used to specify said defect, and determining whether a first claim code data corresponding to said post-temporal registration claim code data is stored in said claim code database;
(c) extracting a post-temporal registration parts number data from said temporal registration data, retrieves a parts number database storing parts number data used to specify a parts in which a defect has occurred, and determining whether a first parts number data corresponding to said post-temporal registration parts number data is stored in said parts number database, when said first claim code data is stored in said claim code database;
(d) determining whether an attached image data is actually attached to said temporal registration data as an attached file of said e-mail, when said first parts number data is stored in said parts number database and it is necessary for said temporal registration data to have attached image data;
(e) determining whether said temporal registration data conforms to a predetermined rule to be appropriate;
(f) retrieving a claim history database storing parts number data and claim history data in which said parts number data and said claim history data are related to each other, and determining whether a first claim history data corresponding to said post-temporal registration parts number data is stored in said claim history database, when said temporal registration data is appropriate;
(g) retrieving a delivery result database storing delivery result data indicating delivery results of parts corresponding to parts data, and determines whether a first delivery result data indicating a delivery result of a parts corresponding to said post-temporal registration parts number data is stored in said delivery result database;
(h) classifying an occurrence cause of a defect corresponding to said temporal registration data which is appropriate based on said post-temporal registration claim code data extracted by said step (b), and generates a classification data, when said first delivery result data is stored in said delivery result database;
(i) determining an investigation execution section that investigates countermeasures on said occurrence causes, based on said classification data;
(j) registering said temporal registration data as a formal registration data in a formal registration database;
(k) generating an investigation execution request message indicating a request for investigation execution, and sends to said investigation execution section;
(l) extracting said formal registration data from said formal registration database, retrieves a countermeasure status database storing countermeasure status data indicating countermeasure statuses of past defects of said parts, determining whether a countermeasure was executed in the past on a defect data same as a first defect data indicating said defect contained in said formal registration data, and transmitting a first countermeasure execution data indicating a new countermeasure submitted by said investigation execution section to said e-mail sender when said countermeasure was not executed;
(m) determining whether said first defect data includes a data with respect to a continuous failure, when said countermeasure was executed in the past on said first defect data, and transmitting a second countermeasure execution data indicating said countermeasure extracted from said countermeasure status database to said e-mail sender when said first defect data includes said data with respect to said continuous failure;
(n) generating a post-processing data in which said formal registration data is related to said determination results by said step (l) and said step (m), and storing said post-processing data in said formal registration database;
(o) calculating a defect responsibility rate based on said post-processing data;
(p) retrieving a price database storing parts price data indicating market supply prices of parts corresponding to said parts number, and extracting a price data indicating a price of a first parts corresponding to a parts number included in said post-processing data;
(q) retrieving an expense database storing expense data indicating expenses when parts are supplied, and extracting an expense data indicating an market supply expense of said first parts;
(r) calculating a remuneration data based on said defect responsibility rate, said price data and said expense data;
(s) calculating a monetary amount based on said remuneration data and an exchange rate;
(t) determining an actual payment amount based on said monetary amount;
(u) generating a payment notice message notifying said payment amount, and transmitting another e-mail with said payment notice message to a sender of said e-mail;
(v) generating an impropriety message, and transmitting still another e-mail with said impropriety message to said sender of said e-mail, when determining said temporal registration data is not appropriate in said step (e);
(w) generating a post-countermeasure data indicating a countermeasure completion, and stores said post-countermeasure data, which is related to said parts number data included in said formal registration data, in said countermeasure status database, when said countermeasure was executed in the past on said first defect data; and
(x) displaying said countermeasure execution data on a display of an information terminal of said e-mail sender to execute one of said countermeasure and said new countermeasure.

5. The quality problem treatment supporting method according to claim 4, further comprising:
(y) executing one of said countermeasure and said new countermeasure indicated in said countermeasure execution data to treat said defect said sender.

6. A computer program embodied on a computer-readable medium and comprising code that, when executed, causes a computer to perform the following:
(a) reading out a temporal registration data, which indicates information with respect to a defect on a parts placing on the market, from a temporary registration database;
(b) extracting a post-temporal registration claim code data from said temporal registration data, retrieving a claim code database storing claim code data used to specify said defect, and determining whether a first claim code data corresponding to said post-temporal registration claim code data is stored in said claim code database;
(c) extracting a post-temporal registration parts number data from said temporal registration data, retrieves a parts number database storing parts number data used to specify a parts in which a defect has occurred, and determining whether a first parts number data corresponding to said post-temporal registration parts number data is stored in said parts number database, when said first claim code data is stored in said claim code database;
(d) determining whether an attached image data is actually attached to said temporal registration data as an attached file of said e-mail, when said first parts number data is stored in said parts number database and it is necessary for said temporal registration data to have attached image data;
(e) determining whether said temporal registration data conforms to a predetermined rule to be appropriate;
(f) retrieving a claim history database storing parts number data and claim history data in which said parts number data and said claim history data are related to each other, and determining whether a first claim history data corresponding to said post-temporal registration parts number data is stored in said claim history database, when said temporal registration data is appropriate;
(g) retrieving a delivery result database storing delivery result data indicating delivery results of parts corresponding to parts data, and determines whether a first delivery result data indicating a delivery result of a parts corresponding to said post-temporal registration parts number data is stored in said delivery result database;
(h) classifying an occurrence cause of a defect corresponding to said temporal registration data which is appropriate based on said post-temporal registration claim code data extracted by said step (b), and generates a classification data, when said first delivery result data is stored in said delivery result database;
(i) determining an investigation execution section that investigates countermeasures on said occurrence causes, based on said classification data;
(j) registering said temporal registration data as a formal registration data in a formal registration database;
(k) generating an investigation execution request message indicating a request for investigation execution, and sends to said investigation execution section;
(l) extracting said formal registration data from said formal registration database, retrieves a countermeasure status database storing countermeasure status data indicating countermeasure statuses of past defects of said parts, determining whether a countermeasure was executed in the past on a defect data same as a first defect data indicating said defect contained in said formal registration data, and transmitting a first countermeasure execution data indicating a new countermeasure submitted by said investigation execution section to said e-mail sender when said countermeasure was not executed;
(m) determining whether said first defect data includes a data with respect to a continuous failure, when said countermeasure was executed in the past on said first defect data, and transmitting a second countermeasure execution data indicating said countermeasure extracted from said countermeasure status database to said e-mail sender when said first defect data includes said data with respect to said continuous failure;
(n) generating a post-processing data in which said formal registration data is related to said determination results by said step (l) and said step (m), and storing said post-processing data in said formal registration database;
(o) calculating a defect responsibility rate based on said post-processing data;
(p) retrieving a price database storing parts price data indicating market supply prices of parts corresponding to said parts number, and extracting a price data indicating a price of a first parts corresponding to a parts number included in said post-processing data;
(q) retrieving an expense database storing expense data indicating expenses when parts are supplied, and extracting an expense data indicating an market supply expense of said first parts;
(r) calculating a remuneration data based on said defect responsibility rate, said price data and said expense data;
(s) calculating a monetary amount based on said remuneration data and an exchange rate;
(t) determining an actual payment amount based on said monetary amount;
(u) generating a payment notice message notifying said payment amount, and transmitting another e-mail with said payment notice message to a sender of said e-mail;
(v) generating an impropriety message, and transmitting still another e-mail with said impropriety message to said sender of said e-mail, when determining said temporal registration data is not appropriate in said step (e); and
(w) generating a post-countermeasure data indicating a countermeasure completion, and stores said post-countermeasure data, which is related to said parts number data included in said formal registration data, in said countermeasure status database, when said countermeasure was executed in the past on said first defect data,
wherein an information terminal of said e-mail sender displays said countermeasure execution data on a display to execute one of said countermeasure and said new countermeasure for repairing said defect.
